(19) United States
(12) Patent Application Publication
(10) Pub. No.: US 2004/0081069 A1
(43) Pub. Date: Apr. 29, 2004

(54) Optical information-recording medium and method for producing the same

(75) Inventors: Masashi Suenaga, Moriya-shi (JP); Yusuke Takahashi, Moriya-shi (JP); Katsunori Miyata, Yuki-gun (JP)

Correspondence Address: OLIFF & BERRIDGE, PLC, P.O. BOX 19928, ALEXANDRIA, VA, 22320, US

(73) Assignee: HITACHI MAXELL, LTD., Ibaraki-shi (JP)

(21) Appl. No.: 10/684,359

(22) Filed: Oct. 15, 2003

(30) Foreign Application Priority Data
Oct. 17, 2002 (JP) 2002-302829
Feb. 17, 2003 (JP) 2003-037688
Jul. 3, 2003 (JP) 2003-270621

(51) Int. Cl. G11B 7/24

(52) U.S. Cl. 369/275.4

(57) ABSTRACT

An optical information-recording medium comprising a substrate which is formed with a plurality of lands and grooves, and a recording layer and a reflective layer which are provided on the substrate, is provided. The grooves include a first groove, a second groove which is formed with pits, and a third groove which is formed with pits having widths narrower than those of the pits of the second groove, wherein the third groove is arranged between the first groove and the second groove. With the optical information-recording medium based on the use of the substrate as described above, even when the tracking is performed to span the boundary between the area in which the in-groove pits are formed and the area in which only the groove is formed, then the radial push-pull signal is scarcely disturbed, and it is possible to perform the stable tracking.

### BACKGROUND OF THE INVENTION

1. Field of the Invention

The present invention relates to an optical information-recording medium. In particular, the present invention relates to an optical information-recording medium on which media information including, for example, the name of the manufacturer and the information concerning copyright protection measures is written in a form of prepits.

1. Description of the Related Art

In recent years, DVD (digital versatile disk), which has a recording capacity several times that of CD (compact disk), is widely used as an information-recording medium on which information including, for example, voices and images of movies and so on is recorded. In addition to DVD, those having been already available as commercial products include DVD-R (write-once type digital versatile disk) on which information can be recorded by a user only once, and DVD-R (rewritable type digital versatile disk) on which information is rewritable. Widespread use of them is considered to become universal as information-recording media having large capacities in future.

Usually, in the case of DVD-R and DVD-RW, the information (hereinafter referred to as “media information”), which includes, for example, the information of the disk manufacturer and the information on the copyright protection measures, is previously stored on the innermost circumferential portion or the outermost circumferential portion of the disk. The media information is recorded at the final stage of the disk production steps such that the recording layer is modified, for example, by radiating a light beam by using a recording apparatus. On the other hand, a method is disclosed (see, for example, Japanese Patent Application Laid-open No. 2001-67733, pages 5 to 6, FIGS. 1 to 3), in which the media information is not recorded in the recording layer in the above manner, but the media information is previously recorded in a form of emboss pits (hereinafter referred to as “in-groove pits”) on the groove of the substrate at the stage of the substrate production of the disk. A part of an optical information-recording medium manufactured by using this method is shown in FIG. 1. FIG. 1A shows a partial magnified plan view illustrating the optical information-recording medium, which schematically depicts an area (hereinafter referred to as “in-groove pit area”) in which in-groove pits are formed. FIGS. 1B and 1C show a sectional view taken along a line 1B-1B and a sectional view taken along a line 1C-1C shown in FIG. 1A respectively. As shown in FIG. 1B, the optical information-recording medium is formed such that the depth dp″, which ranges to the bottom surface (lowermost surface) 107a of the in-groove pit 107 on the basis of the land surface 101a of the substrate 101 formed with the land and the groove, is deeper than the depth dg″ which ranges to the bottom surface (lowermost surface) 105a of the groove 105 on the basis of the land surface 101a as well. Accordingly, when a recording layer 102 and a reflective layer 103 are formed on the pattern formation surface of the substrate 101, the difference in surface height of each of layers to be formed appears between the portion at which the in-groove pit 107 is formed and the portion of the groove at which the in-groove pit 107 is not formed. Therefore, it is possible to record the data such as the media information on the groove by utilizing the difference in depth between the in-groove pit portion and the groove portion.

The optical information-recording medium, in which the recording layer is formed by applying a solution containing an organic dye by using the spin coat method, is formed such that the thickness of the recording layer on the outer side (outer circumferential portion) is thicker than the thickness of the recording layer on the inner side (inner circumferential portion) of the medium. The difference in thickness differs depending on the types of the organic dye material and the solvent to be used. However, the difference is caused by the development from the inner side to the outer side of the substrate, of the solution of the organic dye material and the drying of the solvent during the spin coat. As a result, the recording layer, which is formed on the guide groove formed on the substrate surface of the medium, is formed such that the recording layer is thicker on the outer side than on the inner side of the medium. The difference in thickness has caused the following problems. That is, the reflectance is varied between the inner side and the outer side of the optical information-recording medium, resulting in nonuniformity of various characteristics including, for example, the degrees of modulation of the recording and reproduction signals and the push-pull signal. As a means for dissolving the inconvenience as described above, a method is disclosed (see, for example, Japanese Patent Application Laid-open No. 2002-237100, columns 5 to 6), in which the groove of the substrate, on which the recording layer is formed, is previously formed such that the groove is deepened and widened in a direction directed from the inner circumference to the outer circumference of the substrate.

When the optical information-recording medium, which has the in-groove pits as described above, is used to actually record and reproduce information, an error, in which the tracking is deviated, is often confirmed when the tracking is performed over the boundary between the ingroove pit area and the area (hereinafter referred to as “groove area”) in which only the groove is formed as a user recording area. As shown in FIG. 15, this error is caused by the fact that the side wall of the adjoining land 152 is scraped or eroded due to the formation of the in-groove pit 151 on the substrate. When the side wall of the adjoining land 152 is eroded, the areal size of the upper surface of the land 152 disposed between the in-groove pit 151 and the groove 153 is smaller than the areal size of the upper surface of the land 154 disposed between the ordinary grooves 153. As a result, the difference also arises in areal sizes of the reflective layer and the recording layer to be formed on the land 152 and the land 154. when the groove 153, which is disposed between the land 152 and the land 154, is subjected to the tracking with a light spot SP, then any difference arises between the amount of light of the reflected light beam RF1 obtained from the land 154 and the amount of light of the reflected light beam RF2 obtained from the land 152, and the radial push-pull signal is consequently offset, even when the light spot SP is located at the center of the groove 153. Therefore, it is impossible to perform any satisfactory tracking on the groove, resulting in the increase in jitter and the decrease in degree of modulation. Further, the tracking is deviated in some cases.

In the actual detection of the radial push-pull signal, when an optical pickup having a wavelength λ=650 nm and a numerical aperture NA=0.6 is used, the optical information-recording medium is scanned in the radial direction across a light spot approximately having a diameter φ=1 μm. During this operation, the optical information-recording medium is rotated at a high speed. Therefore, the medium is not scanned across the light spot in the direction perpendicular to the track direction, but the medium is scanned in a direction having a gentle angle formed with respect to the track direction. The radial push-pull signal does not have a frequency characteristic enough to successfully resolve and detect the pits. Therefore, the operation is equivalent to the detection of a groove having a wide width at the in-groove pit portion formed to be deeper than the groove. Therefore, this operation is executed as if the width of the groove is extremely changed critically at the boundary between the in-groove pit area and the groove area. Thus, the radial push-pull signal is disturbed.

In particular, in the case of DVD-R and DVD-RW, the tracking is performed by using the radial push-pull signal. Any tracking error is caused by the disturbance and/or the offset of the radial push-pull signal. Therefore, it is necessary for DVD-R and DVD-RW to avoid the tracking error.

The substrate of the optical information-recording medium having the in-groove pits is usually manufactured with a master disk etched by using an RIE apparatus. However, in ordinary cases, when the groove is formed on the surface of the master disk by performing the etching with the RIE apparatus, the depth of the formed groove is substantially constant. It.has been difficult to form a groove which is continuously deepened in the direction from the inner side to the outer side, on the surface of the master disk.

### SUMMARY OF THE INVENTION

Accordingly, an object of the present invention is to provide an optical information-recording medium which makes it possible to obtain a stable radial push-pull signal even when the tracking is performed over a boundary portion between the in-groove pit area and the groove area, and a method for producing the same.

Another object of the present invention is to provide an optical information-recording medium which is formed with a recording layer composed of a dye material and which has in-groove pits, wherein various characteristics are uniform by suppressing the reflectance from being varied between the inner side and the outer side of the medium, and a method for producing the same.

According to a first aspect of the present invention, there is provided an optical information-recording medium comprising a substrate which is formed with a plurality of lands and grooves, and a recording layer and a reflective layer which are provided on the substrate, the grooves including:

a first groove;

a second groove which is formed with pits; and

a third groove which is formed with pits having widths narrower than those of the pits of the second groove, wherein:

the third groove is arranged between the first groove and the second groove.

The plurality of lands and grooves are formed on the substrate of the optical information-recording medium of the present invention. Pits (in-groove pits) are formed in a part of the grooves. An area (hereinafter referred to as “boundary pit area”), in which in-groove pits having widths narrower than those of the in-groove pits described above, is further provided at the boundary portion between an area (in-groove pit area) in which the in-groove pits are formed and an area (groove area) in which only the groove is formed. Accordingly, a gentle change of shape is obtained over the range from the in-groove pit area to the groove area on the substrate surface. Therefore, in the case of the optical information-recording medium based on the use of the substrate as described above, even when the tracking is performed to span the boundary between the area in which the in-groove pits are formed and the area in which only the groove is formed, then the radial push-pull signal is scarcely disturbed, and it is possible to perform the stable tracking.

It is preferable for the optical information-recording medium of the present invention that Wg≦Wpb≦Wp is satisfied provided that Wg represents a half value width of the first groove, Wp represents a half value width of the pit of the second groove, and Wpb represents a half value width of the pit of the third groove.

In the present invention, it is desirable that Tg≦Tpb≦Tp is satisfied provided that Tg represents a recording layer recess depth ranging from an interface between the recording layer and the reflective layer over a surface of the land to an interface between the recording layer and the reflective layer over the first groove, Tp represents a recording layer recess depth ranging from the interface between the recording layer and the reflective layer over the surface of the land to an interface between the recording layer and the reflective layer over the pit of the second groove, and Tpb represents a recording layer recess depth ranging from the interface between the recording layer and the reflective layer over the surface of the land to an interface between the recording layer and the reflective layer over the pit of the third groove. Accordingly, it is possible to reduce the disturbance of the radial push-pull signal.

In the present invention, it is desirable that the pits, which are formed in the identical groove of the grooves, include a first pit and a second pit which has a length in a groove direction longer than that of the first pit, and 1≦W₂/W₁<1.2 is satisfied provided that W₁ represents a maximum width in a radial direction of the substrate of the first pit, and W₂ represents a maximum width in the radial direction of the substrate of the second pit.

In the present invention, it is desirable that the recording layer is formed of a dye material. It is desirable that the dye material is an azo dye material. The recording layer may contain tellurium. Accordingly, it is possible to form the recording layer with the stable thickness irrelevant to places thereof.

In the optical information-recording medium of the present invention, it is desirable that each of the first groove, the second groove, and the third groove is formed so that a groove depth is continuously deepened and a groove width is continuously widened in a direction from an inner side to an outer side of the optical information-recording medium. Accordingly, even when the recording layer composed of the dye material is formed on the substrate by the spin application, the recording layer can be formed so that the height of the interface between the recording layer and the reflective layer at the groove portion is substantially identical over the entire range from the inner side to the outer side of the optical information-recording medium.

In the present invention, it is desirable that Wgi<Wgo≦Wpb<Wp is satisfied provided that Wgi represents a half value width of the first groove positioned on the inner side of the optical information-recording medium, Wgo represents a half value width of the first groove positioned on the outer side of the optical information-recording medium, Wp represents a half value width of the pit of the second groove, and Wpb represents a half value width of the pit of the third groove. It is desirable that a ratio Wgo/Wgi between the half value width Wgi and the half value width Wgo satisfies 1.03≦Wgo/Wgi≦1.10. When Wgo/Wgi<1.03 holds, then the recording layer recess depth corresponding to the groove portion is shallowed over the range from the inner side to the outer side of the optical information-recording medium, and the recess width is narrowed. As a result, the push-pull signal is lowered on the outer side of the medium, the recording density is lowered as well, and the balance is collapsed between the inner side and the outer side of the medium. When Wgo/Wgi>1.10 holds, then the recording layer recess depth corresponding to the groove portion is deepened over the range from the inner side to the outer side of the optical information-recording medium, and the recess width is widened. As a result, the push-pull signal is increased on the outer side, the recording density is increased as well, and the balance is collapsed between the inner side and the outer side of the medium.

In the present invention, it is desirable that a ratio dgo/dgi between a depth dgi and a depth dgo satisfies 1.00<dgo/dgi≦1.10 provided that dgi represents the depth of the first groove positioned on the inner side of the optical information-recording medium from a substrate surface, and dgo represents the depth of the first groove positioned on the outer side of the optical information-recording medium from the substrate surface. When dgo/dgi≦1.00 holds, then the recording layer recess depth corresponding to the groove portion is shallowed over the range from the inner side to the outer side of the optical information-recording medium. As a result, the push-pull signal is lowered on the outer side of the medium, and the balance is collapsed between the inner side and the outer side of the medium. When dgo/dgi>1.10 holds, then the recording layer recess depth corresponding to the groove portion is deepened over the range from the inner side to the outer side of the optical information-recording medium. As a result, the push-pull signal is increased on the outer side of the medium, and the balance is collapsed between the inner side and the outer side of the medium. Further, when dgo/dgi>1.10 holds, the reflectance of light at the groove portion is lowered, because the groove portion on the outer side of the medium is too deep.

In the present invention, it is desirable that Tgi=Tgo<Tpb<Tp is satisfied provided that Tgi represents a recording layer recess depth ranging from an interface between the recording layer and the reflective layer over a surface of the land to an interface between the recording layer and the reflective layer over the first groove positioned on the inner side of the optical information-recording medium, Tgo represents a recording layer recess depth ranging from the interface between the recording layer and the reflective layer over the surface of the land to an interface between the recording layer and the reflective layer over the first groove positioned on the outer side of the optical information-recording medium, Tp represents a recording layer recess depth ranging from the interface between the recording layer and the reflective layer over the surface of the land to an interface between the recording layer and the reflective layer over the pit of the second groove, and Tpb represents a recording layer recess depth ranging from the interface between the recording layer and the reflective layer over the surface of the land to an interface between the recording layer and the reflective layer over the pit of the third groove. Accordingly, it is possible to reduce the disturbance of the radial push-pull signal.

In the optical information-recording medium of the present invention, it is desirable that a ratio Wp/Wpb between the half value width Wp and the half value width Wpb satisfies 1.05≦Wp/Wpb≦1.15. When Wp/Wpb<1.05 holds, the offset and/or the disturbance tends to appear in the radial push-pull signal obtained from the first groove. When 1.15<Wp/Wpb holds, the degree of modulation of the signal obtained from the in-groove pits formed in the third groove is lowered, which is undesirable.

According to a second aspect of the present invention, there is provided a method for producing the optical information-recording medium as defined in the first aspect, comprising:

exposing a photosensitive material with a pattern corresponding to a first groove, pits of a second groove, and pits of a third groove by irradiating the photosensitive material formed on a master disk with three different exposure intensities;

developing the master disk after the exposure to form the pattern corresponding to the first groove, the second groove equipped with the pits, and the third groove equipped with the pits;

forming a substrate with the master disk on which the pattern is formed; and

forming a recording layer and a reflective layer on the substrate. When this production method is used, it is possible to produce the optical information-recording medium as defined in the first aspect of the present invention.

It is desirable that the production method of the present invention further comprises performing etching by means of RIE in the development. It is desirable that the exposure is performed with the pattern corresponding to the first groove, the second groove, and the third groove by effecting radiation with an exposure intensity which is continuously changed in a direction from an inner side to an outer side of the master disk. Accordingly, the portion, which corresponds to the groove to be formed on the master disk, can be formed so that the portion is widened in the direction from the inner side to the outer side of the master disk. It is desirable that the etching based on RIE is performed while changing a flow rate of a gas to be used for RIE between the inner side and the outer side of the master disk. Accordingly, the portion, which corresponds to the groove to be formed on the master disk, can be formed by using RIE so that the portion is deepened in the direction from the inner side to the outer side of the master disk.

In the method for producing the optical information-recording medium of the present invention, it is desirable that the exposure intensity is changed during the exposure with the pattern corresponding to the pits such that a first exposure intensity is firstly used, a second exposure intensity, which is lower than the first exposure intensity, is used thereafter, and then the exposure intensity is changed to the first exposure intensity. Accordingly, even when the in-groove pit having a long pit length is formed, it is possible to suppress the width from being widened in the radial direction of the substrate, for the following reason. That is, it is possible to apply a substantially constant totalized amount of exposure throughout the pit by reducing the totalized amount of exposure in the period in which the exposure is performed with the second exposure intensity during the exposure of the master disk. It is desirable that periods, in which the exposure is performed with the first exposure intensity, are set to 1 T to 1.5 T respectively provided that T represents a clock cycle used when the optical information-recording medium is subjected to reproduction. It is desirable that the method further comprises performing the exposure with an exposure intensity of zero (0) in addition to the exposure intensities during the exposure of the master disk.

According to a third aspect of the present invention, there is provided an optical information-recording medium comprising a substrate which is formed with a plurality of lands and grooves, and a recording layer and a reflective layer which are provided on the substrate, the grooves including:

a first groove;

a second groove which has a width wider than that of the first groove; and

a third groove which is formed with pits, wherein:

the second groove is arranged between the first groove and the third groove.

The plurality of lands and grooves are formed on the substrate of the optical information-recording medium of the present invention. In-groove pits are formed in a part of the grooves. An area (hereinafter referred to as “boundary groove area”), in which the groove (hereinafter referred to as “boundary groove”) having the width wider than that of the ordinary groove, is further provided at the boundary portion between the in-groove pit area and the groove area. In the optical information-recording medium based on the use of the substrate, the groove width is gently changed between the adjacent grooves over the range ranging from the in-groove pit area to the groove area, as compared with an optical information-recording medium on which only the in-groove pits and the groove are formed. Therefore, the radial push-pull signal is scarcely disturbed, and it is possible to perform the stable tracking.

In the present invention, it is desirable that Wg≦Wgb≦Wp is satisfied provided that Wg represents a half value width of the first groove, Wgb represents a half value width of the second groove, and Wp represents a half value width of the pit of the third groove. In order to sufficiently suppress the disturbance and the offset of the radial push-pull signal, it is desirable that a ratio Wgb/Wg between the half value width Wgb and the half value width Wg satisfies 1.05≦Wgb/Wg≦1.15.

In the present invention, it is desirable that Tg≦Tgb≦Tp is satisfied provided that Tg represents a recording layer recess depth ranging from an interface between the recording layer and the reflective layer over a surface of the land to an interface between the recording layer and the reflective layer over the first groove, Tgb represents a recording layer recess depth ranging from the interface between the recording layer and the reflective layer over the surface of the land to an interface between the recording layer and the reflective layer over the second groove, and Tp represents a recording layer recess depth ranging from the interface between the recording layer and the reflective layer over the surface of the land to an interface between the recording layer and the reflective layer over the pit of the third groove. It is desirable that the pits, which are formed in the identical groove of the grooves, include a first pit and a second pit which has a length in a groove direction longer than that of the first pit, and 1≦W₂/W₁<1.2 is satisfied provided that W₁ represents a maximum width in a radial direction of the substrate of the first pit, and W₂ represents a maximum width in the radial direction of the substrate of the second pit.

In the present invention, it is desirable that the recording layer is formed of a dye material. It is desirable that the dye material is an azo dye material. The recording layer may contain tellurium.

In the optical information-recording medium of the present invention, it is desirable that each of the first groove and the third groove is formed so that a groove depth is continuously deepened and a groove width is continuously widened in a direction from an inner side to an outer side of the optical information-recording medium. Accordingly, even when the recording layer composed of the dye material is formed on the substrate by means of the spin application, the recording layer can be formed so that the height of the interface between the recording layer and the reflective layer at the groove portion is substantially identical over the entire range from the inner side to the outer side of the optical information-recording medium.

In the present invention, it is desirable that Wgi<Wgo≦Wgb≦Wp is satisfied provided that Wgi represents a half value width of the first groove positioned on the inner side of the optical information-recording medium, Wgo represents a half value width of the first groove positioned on the outer side of the optical information-recording medium, Wgb represents a half value width of the second groove, and Wp represents a half value width of the pit of the third groove. It is desirable that a ratio Wgo/Wgi between the half value width Wgi and the half value width Wgo satisfies 1.03≦Wgo/Wgi≦1.10. When Wgo/Wgi<1.03 holds, then the recording layer recess depth corresponding to the groove portion is shallowed over the range from the inner side to the outer side of the optical information-recording medium, and the recess width is narrowed. As a result, the push-pull signal is lowered on the outer side of the medium, the recording density is lowered as well, and the balance is collapsed between the inner side and the outer side of the medium. When Wgo/Wgi>1.10 holds, then the recording layer recess depth corresponding to the groove portion is deepened over the range from the inner side to the outer side of the optical information-recording medium, and the recess width is widened. As a result, the push-pull signal is increased on the outer side, the recording density is increased as well, and the balance is collapsed between the inner side and the outer side of the medium.

In the present invention, it is desirable that a ratio dgo/dgi between a depth dgi and a depth dgo satisfies 1.00<dgo/dgi≦1.10 provided that dgi represents the depth of the first groove positioned on the inner side of the optical information-recording medium from a substrate surface, and dgo represents the depth of the first groove positioned on the outer side of the optical information-recording medium from the substrate surface. When dgo/dgi≦1.00 holds, then the recording layer recess depth corresponding to the groove portion is shallowed over the range from the inner side to the outer side of the optical information-recording medium. As a result, the push-pull signal is lowered on the outer side of the medium, and the balance is collapsed between the inner side and the outer side of the medium. When dgo/dgi>1.10 holds, then the recording layer recess depth corresponding to the groove portion is deepened over the range from the inner side to the outer side of the optical information-recording medium. As a result, the push-pull signal is increased on the outer side of the medium, and the balance is collapsed between the inner side and the outer side of the medium. Further, When dgo/dgi>1.10 holds, the reflectance of light at the groove portion is lowered, because the groove portion on the outer side of the medium is too deep.

In the present invention, it is desirable that Tgi=Tgo<Tgb<Tp is satisfied provided that Tgi represents a recording layer recess depth ranging from an interface between the recording layer and the reflective layer over a surface of the land to an interface between the recording layer and the reflective layer over the first groove positioned on the inner side of the optical information-recording medium, Tgo represents a recording layer recess depth ranging from the interface between the recording layer and the reflective layer over the surface of the land to an interface between the recording layer and the reflective layer over the first groove positioned on the outer side of the optical information-recording medium, Tgb represents a recording layer recess depth ranging from the interface between the recording layer and the reflective layer over the surface of the land to an interface between the recording layer and the reflective layer over the second groove, and Tp represents a recording layer recess depth ranging from the interface between the recording layer and the reflective layer over the surface of the land to an interface between the recording layer and the reflective layer over the pit of the third groove. Accordingly, it is possible to reduce the disturbance of the radial push-pull signal.

According to a fourth aspect of the present invention, there is provided a method for producing the optical information-recording medium as defined in the third aspect, comprising:

exposing a photosensitive material with a pattern corresponding to a first groove, a second groove, and pits of a third groove by irradiating the photosensitive material formed on a master disk with three different exposure intensities;

developing the master disk after the exposure to form the pattern corresponding to the first groove, the second groove, and the third groove equipped with the pits;

forming a substrate with the master disk on which the pattern is formed; and

forming a recording layer and a reflective layer on the substrate. When this production method is used, it is possible to produce the optical information-recording medium according to the third aspect of the present invention.

In the method for producing the optical information-recording medium of the present invention, it is desirable that the method further comprises performing etching by means of RIE in the development. It is desirable that the exposure is performed with the pattern corresponding to the first groove and the third groove by effecting radiation with an exposure intensity which is continuously changed in a direction from an inner side to an outer side of the master disk. It is desirable that the etching based on RIE is performed while changing a flow rate of a gas to be used for RIE between the inner side and the outer side of the master disk.

In the present invention, it is desirable that the exposure intensity is changed during the exposure with the pattern corresponding to the pits such that a first exposure intensity is firstly used, a second exposure intensity, which is lower than the first exposure intensity, is used thereafter, and then the exposure intensity is changed to the first exposure intensity. It is desirable that periods, in which the exposure is performed with the first exposure intensity, are set to 1 T to 1.5 T respectively provided that T represents a clock cycle used when the optical information-recording medium is subjected to reproduction. Further, it is desirable that the method further comprises performing the exposure with an exposure intensity of zero (0) in addition to the exposure intensities during the exposure of the master disk.

According to a fifth aspect of the present invention, there is provided an optical information-recording medium comprising a substrate which is formed with a plurality of lands and grooves, and a recording layer and a reflective layer which are provided on the substrate, the grooves including:

a first groove;

a second groove which has a width wider than that of the first groove;

a third groove which is formed with pits; and

a fourth groove which is formed with pits having widths narrower than those of the pits of the third groove, wherein:

the first to fourth grooves are arranged in an order of the first groove, the second groove, the fourth groove, and the third groove.

The plurality of lands and grooves are formed on the substrate of the optical information-recording medium of the present invention. In-groove pits are formed in a part of the grooves. The boundary pit area is provided between the in-groove pit area and the groove area. Further, the groove (boundary groove) having the width wider than that of the ordinary groove is provided between the boundary pit area and the groove area. In the optical information-recording medium based on the use of the substrate, the groove width is gently changed between the mutually adjacent grooves in the range ranging from the groove area to the boundary pit area owing to the provision of the boundary groove area. Therefore, it is possible to further suppress the disturbance of the radial push-pull signal as compared with the optical information-recording medium according to the first aspect. The boundary groove area is provided between the groove area and the boundary pit area. Therefore, it is possible to increase the size of the in-groove pit in the boundary pit area, as compared with a case in which the boundary groove area is absent. Accordingly, it is possible to obtain a reproduced signal having a high degree of modulation from the in-groove pits in the boundary pit area.

In the present invention, it is desirable that Wg≦Wgb≦Wpb≦Wp is satisfied provided that Wg represents a half value width of the first groove, Wgb represents a half value width of the second groove, Wp represents a half value width of the third groove, and Wpb represents a half value width of the fourth groove. In order to sufficiently suppress the disturbance and the offset of the radial push-pull signal, it is desirable that a ratio Wgb/Wg between the half value width Wgb and the half value width Wg satisfies 1.03≦Wgb/Wg≦1.15.

In the present invention, it is desirable that Tg≦Tgb≦Tpb≦Tp is satisfied provided that Tg represents a recording layer recess depth ranging from an interface between the recording layer and the reflective layer over a surface of the land to an interface between the recording layer and the reflective layer over the first groove, Tgb represents a recording layer recess depth ranging from the interface between the recording layer and the reflective layer over the surface of the land to an interface between the recording layer and the reflective layer over the second groove, Tp represents a recording layer recess depth ranging from the interface between the recording layer and the reflective layer over the surface of the land to an interface between the recording layer and the reflective layer over the pit of the third groove, and Tpb represents a recording layer recess depth ranging from the interface between the recording layer and the reflective layer over the surface of the land to an interface between the recording layer and the reflective layer over the pit of the fourth groove. Accordingly, it is possible to reduce the disturbance of the radial push-pull signal. Further, it is desirable that the pits, which are formed in the identical groove of the grooves, include a first pit and a second pit which has a length in a groove direction longer than that of the first pit, and 1≦W₂/W₁<1.2 is satisfied provided that W₁ represents a maximum width in a radial direction of the substrate of the first pit, and W₂ represents a maximum width in the radial direction of the substrate of the second pit.

In the present invention, it is desirable that the recording layer is formed of a dye material. It is desirable that the dye material is an azo dye material. The recording layer may contain tellurium.

In the optical information-recording medium of the present invention, it is desirable that each of the first groove, the third groove, and the fourth groove is formed so that a groove depth is continuously deepened and a groove width is continuously widened in a direction from an inner side to an outer side of the optical information-recording medium. Accordingly, even when the recording layer composed of the dye material is formed on the substrate by the spin application, the recording layer can be formed so that the height of the interface between the recording layer and the reflective layer at the groove portion is substantially identical over the entire range from the inner side to the outer side of the optical information-recording medium.

In the present invention, it is desirable that Wgi<Wgo≦Wgb≦Wpb<Wp is satisfied provided that Wgi represents a half value width of the first groove positioned on the inner side of the optical information-recording medium, Wgo represents a half value width of the first groove positioned on the outer side of the optical information-recording medium, Wgb represents a half value width of the second groove, Wp represents a half value width of the pit of the third groove, and Wpb represents a half value width of the pit of the fourth groove. It is desirable that a ratio Wgo/Wgi between the half value width Wgi and the half value width Wgo satisfies 1.03≦Wgo/Wgi≦1.10. When Wgo/Wgi<1.03 holds, then the recording layer recess depth corresponding to the groove portion is shallowed over the range from the inner side to the outer side of the optical information-recording medium, and the recess width is narrowed. As a result, the push-pull signal is lowered on the outer side of the medium, the recording density is lowered as well, and the balance is collapsed between the inner side and the outer side of the medium. When Wgo/Wgi>1.10 holds, then the recording layer recess depth corresponding to the groove portion is deepened over the range from the inner side to the outer side of the optical information-recording medium, and the recess width is widened. As a result, the push-pull signal is increased on the outer side, the recording density is increased as well, and the balance is collapsed between the inner side and the outer side of the medium.

In the present invention, it is desirable that a ratio dgo/dgi between a depth dgi and a depth dgo satisfies 1.00<dgo/dgi≦1.10 provided that dgi represents the depth of the first groove positioned on the inner side of the optical information-recording medium from a substrate surface, and dgo represents the depth of the first groove positioned on the outer side of the optical information-recording medium from the substrate surface. When dgo/dgi≦1.00 holds, then the recording layer recess depth corresponding to the groove portion is shallowed over the range from the inner side to the outer side of the optical information-recording medium. As a result, the push-pull signal is lowered on the outer side of the medium, and the balance is collapsed between the inner side and the outer side of the medium. When dgo/dgi>1.10 holds, then the recording layer recess depth corresponding to the groove portion is deepened over the range from the inner side to the outer side of the optical information-recording medium. As a result, the push-pull signal is increased on the outer side of the medium, and the balance is collapsed between the inner side and the outer side of the medium. Further, if dgo/dgi>1.10 holds, the reflectance of light at the groove portion is lowered, because the groove portion on the outer side of the medium is too deep.

In the present invention, it is desirable that Tgi=Tgo<Tgb<Tpb<Tp is satisfied provided that Tgi represents a recording layer recess depth ranging from an interface between the recording layer and the reflective layer over a surface of the land to an interface between the recording layer and the reflective layer over the first groove positioned on the inner side of the optical information-recording medium, Tgo represents a recording layer recess depth ranging from the interface between the recording layer and the reflective layer over the surface of the land to an interface between the recording layer and the reflective layer over the first groove positioned on the outer side of the optical information-recording medium, Tgb represents a recording layer recess depth ranging from the interface between the recording layer and the reflective layer over the surface of the land to an interface between the recording layer and the reflective layer over the second groove, Tp represents a recording layer recess depth ranging from the interface between the recording layer and the reflective layer over the surface of the land to an interface between the recording layer and the reflective layer over the pit of the third groove, and Tpb represents a recording layer recess depth ranging from the interface between the recording layer and the reflective layer over the surface of the land to an interface between the recording layer and the reflective layer over the pit of the fourth groove. Accordingly, it is possible to reduce the disturbance of the radial push-pull signal.

In the present invention, it is desirable that a ratio Wp/Wpb between the half value width Wp and the half value width Wpb satisfies 1.05≦Wp/Wpb≦1.15. When Wp/Wpb<1.05 holds, the offset and the disturbance are apt to appear in the radial push-pull signal obtained from the first groove. When 1.15<Wp/Wpb holds, the degree of modulation of the signal obtained from the in-groove pits formed in the third groove is lowered, which is undesirable.

According to a sixth aspect of the present invention, there is provided a method for producing the optical information-recording medium as defined in the fifth aspect, comprising:

exposing a photosensitive material with a pattern corresponding to a first groove, a second groove, pits of a third groove, and pits of a fourth groove by irradiating the photosensitive material formed on a master disk with four different exposure intensities;

developing the master disk after the exposure to form the pattern corresponding to the first groove, the second groove, the third groove equipped with the pits, and the fourth groove equipped with the pits;

forming a substrate with the master disk on which the pattern is formed; and

forming a recording layer and a reflective layer on the substrate. When this production method is used, it is possible to produce the optical information-recording medium according to the fifth aspect of the present invention.

In the method for producing the optical information-recording medium of the present invention, it is desirable that the method further comprises performing etching by means of RIE in the development. It is desirable that the exposure is performed with the pattern corresponding to the first groove, the third groove, and the fourth groove by effecting radiation with an exposure intensity which is continuously changed in a direction from an inner side to an outer side of the master disk. It is desirable that the etching based on RIE is performed while changing a flow rate of a gas to be used for RIE between the inner side and the outer side of the master disk.

In the present invention, it is desirable that the exposure intensity is changed during the exposure with the pattern corresponding to the pits such that a first exposure intensity is firstly used, a second exposure intensity, which is lower than the first exposure intensity, is used thereafter, and then the exposure intensity is changed to the first exposure intensity. It is desirable that periods, in which the exposure is performed with the first exposure intensity, are set to 1 T to 1.5 T respectively provided that T represents a clock cycle used when the optical information-recording medium is subjected to reproduction. Further, it is desirable that the method further comprises performing the exposure with an exposure intensity of zero (0) in addition to the exposure intensities during the exposure of the master disk.

According to the present invention, there is provided a master disk which is used for the method for producing the optical information-recording medium as defined in each of the aspects described above, wherein the master disk is formed of glass. Further, according to the present invention, there is provided a stamper which is manufactured with the master disk to be used for the method for producing the optical information-recording medium as defined in each of the aspects described above.

### BRIEF DESCRIPTION OF THE DRAWINGS

FIG. 1A shows a schematic top view illustrating a part of an optical information-recording medium having conventional in-groove pits, FIG. 1B shows a sectional view taken along a line 1B-1B shown in FIG. 1A, and FIG. 1C shows a sectional view taken along a line 1C-1C shown in FIG. 1A.

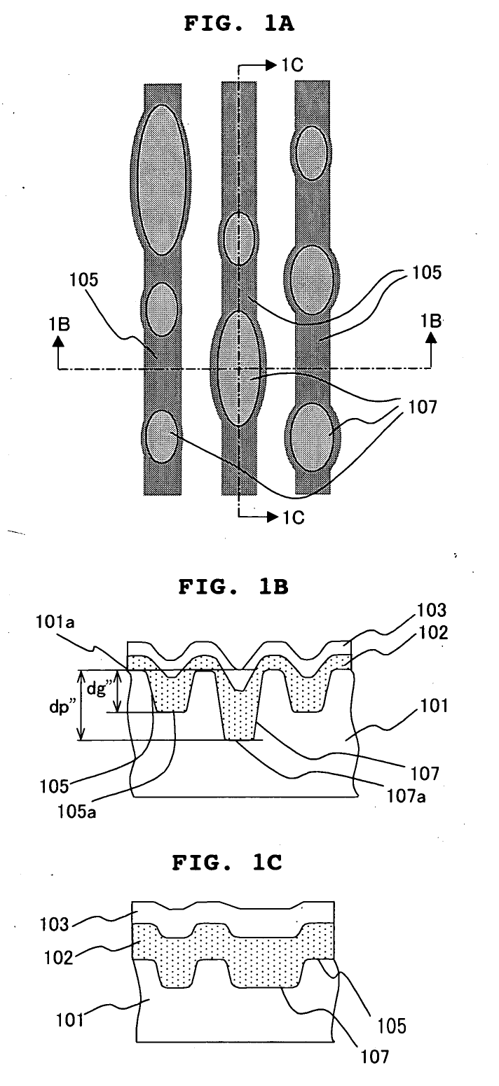

FIGS. 2A to 2C illustrate a method for manufacturing a glass master disk in a first embodiment.

FIG. 3 shows the time-dependent change of the exposure intensity of a laser beam to be radiated onto the glass master disk in the first embodiment.

FIG. 4A shows a schematic top view illustrating a part of the glass master disk obtained immediately after the photoresist exposure and the development in the first embodiment, and FIG. 4B shows a sectional view taken along a line 4B-4B shown in FIG. 4A.

FIGS. 5A to 5D show a method for manufacturing the glass master disk in the first embodiment.

FIG. 6 shows a schematic perspective view illustrating a pattern formation surface of a substrate obtained in the first embodiment.

FIG. 7 schematically shows the substrate obtained in the first embodiment.

FIG. 8A shows a schematic top view illustrating those disposed in the vicinity of a boundary pit area of the optical information-recording medium manufactured in the first embodiment, and FIG. 8B shows a sectional view taken along a line 8B-8B shown in FIG. 8A.

FIG. 9 shows the sum signal and the difference signal (radial push-pull signal) obtained in the vicinity of the boundary portion between the in-groove pit area and the groove area, wherein FIG. 9A shows the respective signals obtained from the information-recording medium prepared in the first embodiment, and FIG. 9B shows the respective signals obtained from an information-recording medium having conventional in-groove pits.

FIG. 10 shows a schematic sectional view illustrating those disposed in the vicinity of a boundary portion between an in-groove pit area and a groove area of an optical information-recording medium obtained in a second embodiment.

FIG. 11 shows the time-dependent change of the exposure intensity of a laser beam to be radiated onto a glass master disk in a third embodiment.

FIG. 12A shows a schematic top view illustrating those disposed in the vicinity of a boundary pit area of an optical information-recording medium obtained in the third embodiment, and FIG. 12B shows a sectional view taken along a line 12B-12B shown in FIG. 12A.

FIG. 13 shows the time-dependent change of the exposure intensity of a laser beam to be radiated onto a glass master disk in a fourth embodiment.

FIG. 14A shows a schematic top view illustrating those disposed in the vicinity of a boundary pit area of an optical information-recording medium obtained in the fourth embodiment, and FIG. 14B shows a sectional view taken along a line 14B-14B shown in FIG. 14A.

FIG. 15 illustrates the cause of appearance of the tracking error which occurs at a boundary between a groove formation area and an in-groove pit formation area.

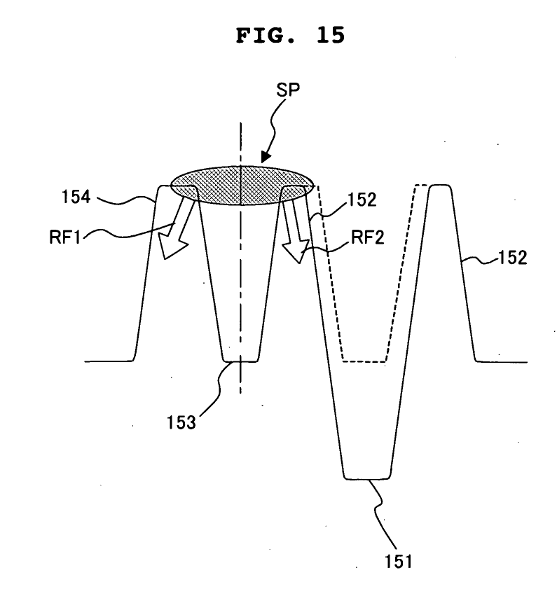

FIG. 16A shows a schematic top view illustrating those disposed in the vicinity of a boundary pit area of an optical information-recording medium obtained in a fifth embodiment, and FIG. 16B shows a sectional view taken along a line 16B-16B shown in FIG. 16A.

FIG. 17 shows the time-dependent change of the exposure intensity in the vicinity of an in-groove pit formation area, of a laser beam to be radiated onto a glass master disk in the fifth embodiment.

FIG. 18 shows the time-dependent change of the exposure intensity over the entire glass master disk, of the laser beam to be radiated onto the glass master disk in the fifth embodiment.

FIG. 19 schematically shows an RIE apparatus used in the fifth embodiment.

### DESCRIPTION OF THE PREFERRED EMBODIMENTS

Embodiments of the present invention will be explained with reference to the drawings. However, the present invention is not limited thereto.

### First Embodiment

Method for Manufacturing Master Disk and Stamper for Manufacturing Substrate

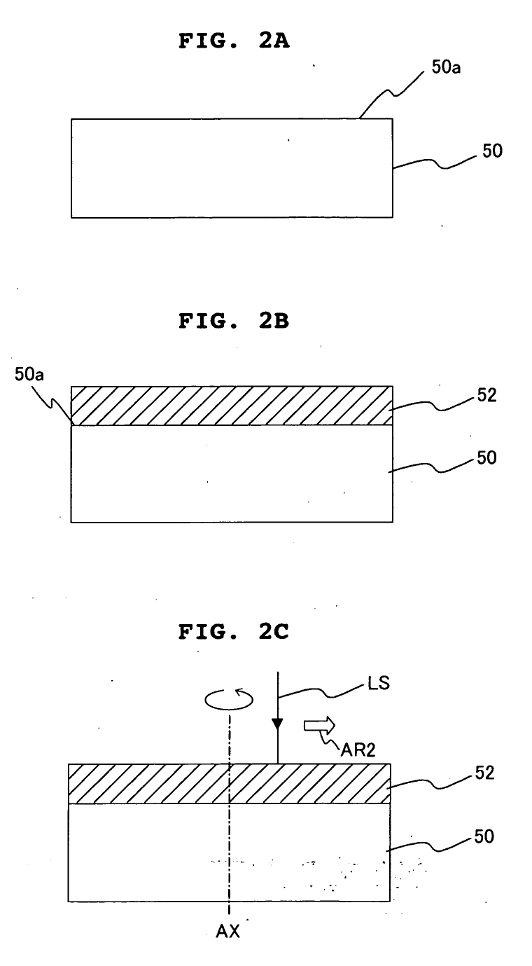

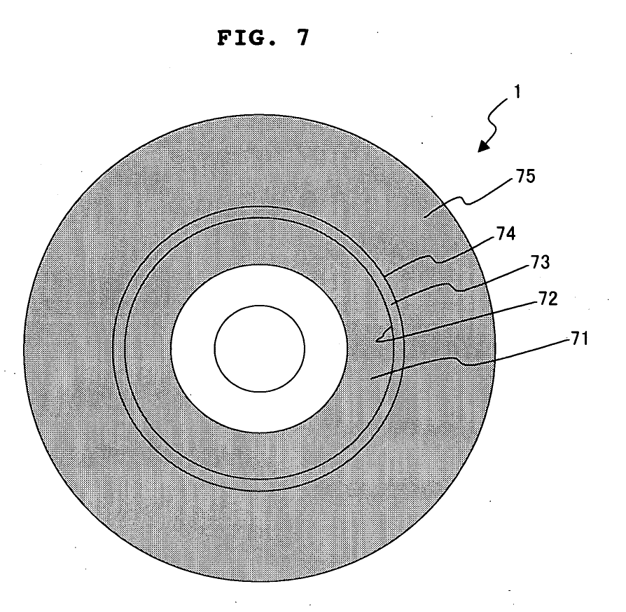

As shown in FIG. 7, a groove area 71, a boundary pit area 72, an in-groove pit area 73, a boundary pit area 74, and a groove area 75 are formed in this order from the inner circumferential side of a substrate 1 on the substrate of an information-recording medium according to the present invention. An explanation will be made with reference to FIGS. 2 to 7 about a method for manufacturing a master disk and a stamper for manufacturing the substrate 1. As shown in FIG. 2A, a glass master disk 50 having a diameter of 200 mm and a thickness of 6 mm was prepared. Subsequently, as shown in FIG. 2B, a photoresist 52 was uniformly applied to have a thickness of 200 nm on one surface 50a of the glass master disk 50 by using the spin coat method. Subsequently, the glass master disk 50, on which the photoresist 52 had been formed, was installed to an unillustrated cutting apparatus. The cutting apparatus principally comprises, for example, a Kr gas laser light source which oscillates a laser beam having a wavelength of 351 nm, an optical modulator which is composed of an acousto-optical modulator element, a light-collecting lens, and a drive unit which rotates the glass master disk. As shown in FIG. 2C, the laser beam LS, which is emitted from the laser light source (not shown) of the cutting apparatus, is radiated onto the photoresist 52 on the glass master disk 50 via the optical modulator and the light-collecting lens. In this procedure, the glass master disk 50 was rotated at a predetermined number of revolutions on the basis of the central axis AX of the glass master disk 50. The radiation position of the laser beam LS on the glass master disk 50 is moved (as indicated by the arrow AR2) from the inner side to the outer side of the glass master disk 50 in the radial direction of the glass master disk 50.

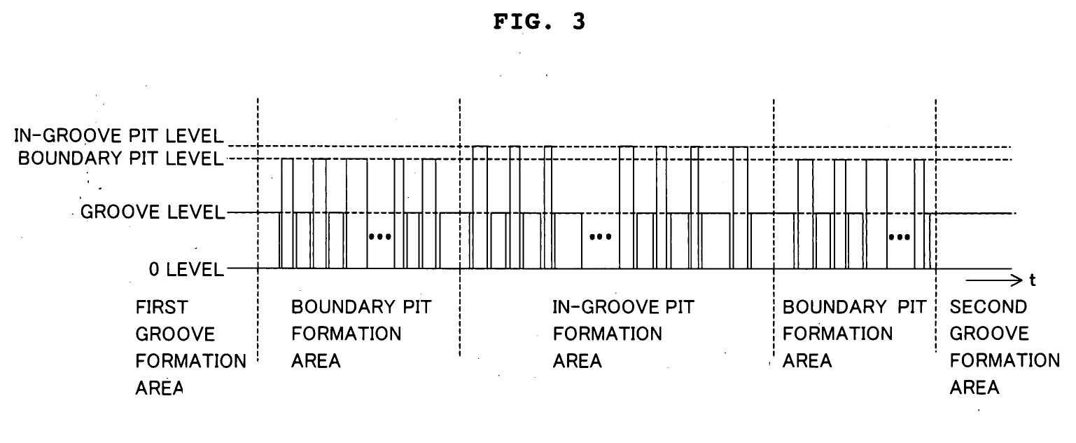

The exposure intensity of the laser beam LS to be radiated onto the glass master disk 50 is changed with the optical modulator while moving the laser beam LS on the glass master disk 50 as described above. In this embodiment, as shown in FIG. 3, the exposure intensity of the laser beam was changed at three levels, i.e., the low level, the middle level, and the high level. An area, which has radiuses of 19.0 mm to 24.0 mm on the basis of the central axis (AX) of the glass master disk, corresponds to the groove area 71 of the substrate 1 shown in FIG. 7 (hereinafter referred to as “first groove formation area”). An area, which has radiuses of 24.0 mm to 24.1 mm, corresponds to the in-groove pit area 73 of the substrate 1 (hereinafter referred to as “in-groove pit formation area”). An area, which has radiuses of 24.1 mm to 58.9 mm, is a user data area which corresponds to the groove area 75 of the substrate 1 (hereinafter referred to as “second groove formation area”). As shown in FIG. 3, the exposure intensity was set to the low level (hereinafter referred to as “groove level”) for the first and second groove formation areas. In the in-groove pit formation area, the exposure intensity, which was adopted when the in-groove pits were formed, was set to the high level (hereinafter referred to as “in-groove pit level”), and the exposure intensity was set to the groove level for groove portion other than the above. An area, which was formed with in-groove pits corresponding to an amount of 1 track (hereinafter referred to as “boundary pit formation area”), was provided at each of the boundaries between the first and second groove formation areas and the in-groove pit formation area. The boundary pit formation area corresponds to each of the boundary pit areas 72, 74 of the substrate 1 shown in FIG. 7. In the boundary pit formation areas, the exposure intensity, which was adopted when the in-groove pits were formed, was set to the middle level (hereinafter referred to as “boundary pit level”), and the exposure intensity was set to the groove level for groove portions other than the above. In this embodiment, the boundary pit level was set to 90% and the groove level was set to 55% provided that the in-groove pit level was 100%. The respective in-groove pits, which are formed in the boundary pit formation area, are formed with any one of the channel bit lengths of 3 T to 11 T or 14 T (T: clock cycle) in the tangential direction of the track. The pattern of the boundary pits formed in 1 track may be a random pattern. The shortest channel bit length can be adjusted in conformity with the reproducing apparatus to be used. In this embodiment, when the exposure intensity was changed during the exposure, the period, in which the exposure intensity of the laser beam was temporarily at the 0 level, was provided every time when the exposure intensity was switched as shown in FIG. 3. Accordingly, the processing accuracy is improved for the in-groove pit portions in the in-groove pit formation area and the boundary pit formation area of the glass master disk.

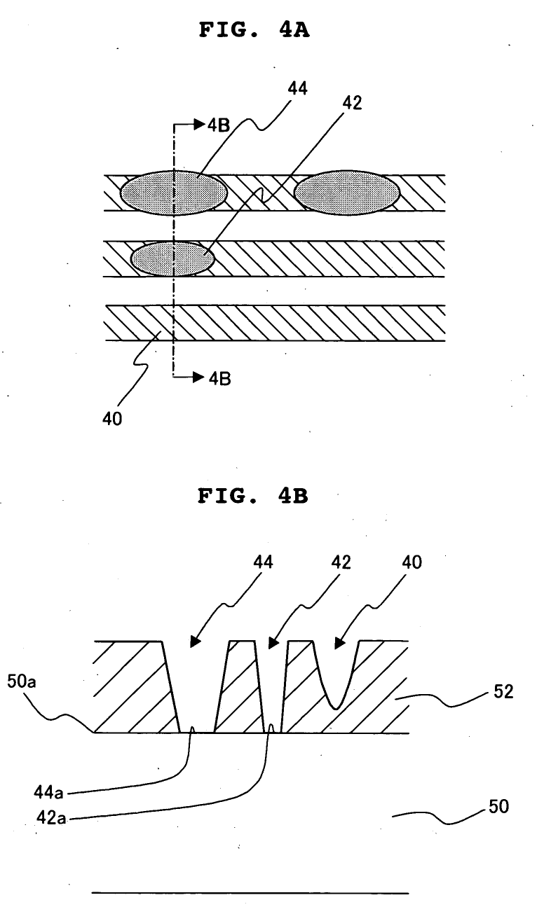

Subsequently, the glass master disk, on which the photoresist had been photosensitized, was taken out from the cutting apparatus to perform a development treatment. Accordingly, as shown in FIGS. 4A and 4B, a groove formation section 40, a boundary pit formation section 42, and an in-groove pit formation section 44 were formed on the glass master disk 50. The groove formation section 40 is formed so that the cross section is V-shaped and groove-shaped. In the boundary pit formation section 42 and the in-groove pit formation section 44, the photoresist 52 is removed from the surface of the glass master disk 50 as a result of the development treatment. As shown in FIG. 4B, the surface 50a of the glass master disk 50 appears as an exposed section 42a and an exposed section 44a respectively. The width of the exposed section 42a in the radial direction of the glass master disk is narrower than the width of the exposed section 44a of the in-groove pit formation section 44.

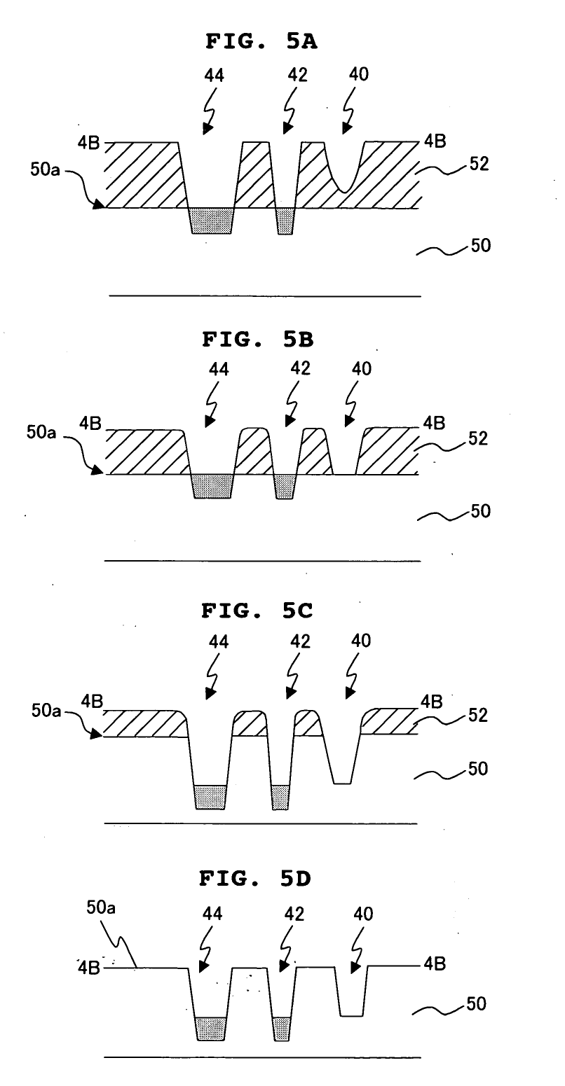

Subsequently, as shown in FIG. 5A, the surface of the photoresist 52 formed on the glass master disk 50 was subjected to the etching in a C₂F₆ gas atmosphere by using an unillustrated RIE (reactive ion etching) apparatus. Accordingly, the in-groove pit formation section 44 and the boundary pit formation section 42 are etched until arrival at a depth of 90 nm from the surface 50a of the glass master disk 50 respectively. Subsequently, as shown in FIG. 5B, in order to expose the surface 50a of the glass master disk 50 at the groove formation section 40, the photoresist 52 was eroded or scraped by a predetermined thickness by using an unillustrated resist ashing apparatus based on O₂. Accordingly, the glass master disk surface 50a was exposed at the groove formation section 40. Further, as shown in FIG. 5C, RIE was performed again in the C₂F₆ gas atmosphere for the formation surface of the photoresist 52 of the glass master disk 50. Accordingly, the groove formation section 40 was etched until arrival at a depth of 170 nm from the glass master disk surface 50a. Simultaneously, the in-groove pit formation section 44 and the boundary pit formation section 42 were etched until arrival at a depth of 260 nm from the glass master disk surface 50a. Subsequently, as shown in FIG. 5D, the resist ashing apparatus (not shown) was used again to remove the photoresist 52 from the surface of the glass master disk 50. Accordingly, the glass master disk 50, which had a desired pattern formed on the surface, was obtained.

Electroless plating was applied as a pretreatment for the plating onto the pattern formation surface of the glass master disk 50. An Ni layer having a thickness of 0.29 mm was formed by means of the electrocasting method by using the plating layer as a conductive film. Subsequently, the surface of the Ni layer formed on the glass master disk 50 was polished, and the Ni layer was exfoliated from the glass master disk. Thus, a stamper was obtained. The conductive film to be formed in the pretreatment for the plating may be formed by using the sputtering method or the vapor deposition method.

Method for Manufacturing Information-Recording Medium

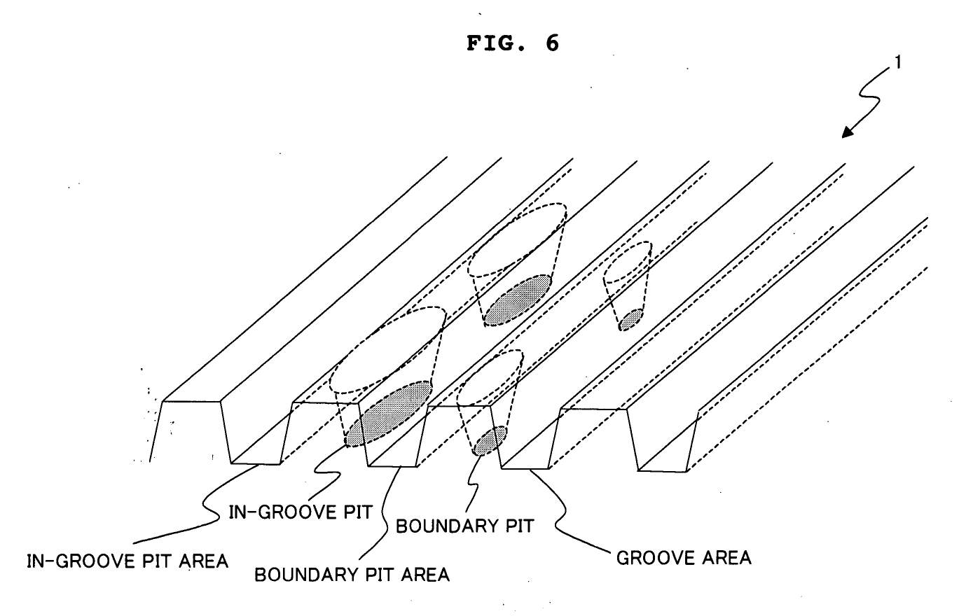

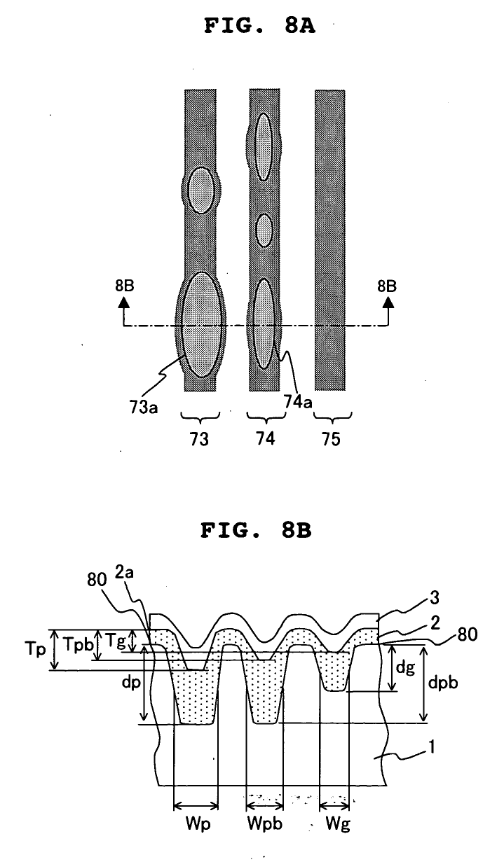

The stamper was installed to an existing injection molding machine, and the substrate 1 was obtained by the injection molding. The substrate 1 is made of polycarbonate having a diameter of 120 mm and a thickness of 0.6 mm. As shown in FIG. 6, the pattern, which has the same shape as the shape of the concave/convex pattern formed on the glass master disk, is transferred onto one surface of the substrate 1. As described above, the groove area 71, the boundary pit area 72, the in-groove pit area 73, the boundary pit area 74, and the groove area (user data area) 75 are formed on the substrate 1 as shown in FIG. 7. A solution, which had a concentration of 1% by weight of an azo dye represented by the following chemical formula (1), was applied onto the pattern formation surface of the substrate 1 by the spin coat method. In this procedure, the solution was applied so that the thickness was 100 nm at the groove portion. When the dye solution was applied, tetrafluoropropanol was used as a solvent to prepare the azo dye solution, and impurities were removed by performing the filtration through a filter. Subsequently, the substrate 1, onto which the dye material had been applied, was dried for 1 hour at 70° C., followed by being cooled for 1 hour at room temperature. Thus, the recording layer 2 was formed on the substrate 1 (see FIG. 8B).

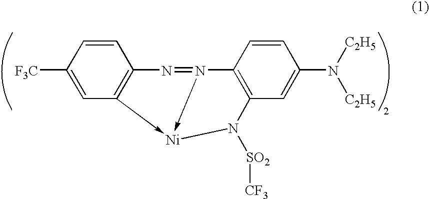

Further, as shown in FIG. 8B, an Ag alloy was formed to have a thickness of 160 nm as the reflective layer 3 on the recording layer 2 by using the sputtering method. Subsequently, a UV-curable resin material was applied onto the reflective layer 3 by means of the spin coat method. Further, a substrate (dummy substrate) made of polycarbonate having a thickness of 0.6 mm was placed thereon. The substrate, on which the respective layers had been formed, was irradiated with UV in this state, and thus the substrate formed with the respective layers and the dummy substrate were stuck to one another to obtain the optical information-recording medium.

The maximum depths of the in-groove pit portion in the in-groove pit area 73, the boundary pit portion in the boundary pit area 74, and the groove portion in the groove area 75 of the optical information-recording medium obtained as described above were measured by using AFM produced by Digital Instruments. As shown in FIG. 8B, the depths were determined from the surface of the land 80 of the substrate. The maximum depth dg of the groove portion was 170 nm. The maximum depth dpb of the boundary pit portion was 260 nm. The maximum depth dp of the in-groove pit portion was 260 nm. It is desirable that the maximum depth dg of the groove portion and the maximum depth dp of the in-groove pit portion satisfy the condition of 1.4≦dp/dg≦1.7 in order to obtain the satisfactory recording and reproduction signal characteristics such as those concerning the degree of signal modulation and the jitter. This condition was determined on the basis of the experiment performed by the present inventors. This condition was also satisfied by the optical information-recording medium of this embodiment. On the other hand, the half value width Wp of the in-groove pit portion in the in-groove pit area 73, the half value width Wpb of the boundary pit portion in the boundary pit area 74, and the half value width Wg of the groove portion in the groove area 75 were measured respectively on the basis of the surface of the land 80 by using AFM produced by Digital Instruments. The half value width herein refers to the groove width or the hole width of the medium in the radial direction at a position of a depth of ½ of the maximum depth of each of the portions on the basis of the reference plane of the surface of the land 80. The half value width Wg was 320 nm, the half value width Wpb was 350 nm, and the half value width Wp was 400 nm. Accordingly, it is appreciated that the relationship of Wg≦Wpb<Wp holds. Further, it is appreciated that the ratio Wp/Wpb=1.14 is established between the half value width Wp and the half value width Wpb, and the condition of 1.05≦Wp/Wpb≦1.15 is satisfied.

Further, as shown in FIG. 8B, the recording layer recess depths of the in-groove pit portion in the in-groove pit area 73, the boundary pit portion in the boundary pit area 74, and the groove portion in the groove area 75 of the obtained optical information-recording medium were measured by using AFM produced by Digital Instruments. The recording layer recess depth herein refers to the maximum recess amount of the recording layer 2 on the basis of the reference of the surface 2a of the recording layer 2 formed on the land 80. The recording layer recess depth Tp in the in-groove pit area 73 was 170 nm. The recording layer recess depth Tpb in the boundary pit area 74 was 135 nm. The recording layer recess depth Tg in the groove area 75 was 100 nm. It is desirable that the recording layer recess depth Tp and the recording layer recess depth Tg satisfy the condition of 1.6≦Tp/Tg≦2.0 in order to obtain the satisfactory recording and reproduction signal characteristics such as those concerning the degree of signal modulation and the jitter. This condition was determined on the basis of the experiment performed by the present inventors. This condition was also satisfied by the optical information-recording medium of this embodiment. The condition, which is satisfied by the recording layer recess depth Tpb in the boundary pit area 74 and the recording layer recess depth Tp in the in-groove pit area 73 or the recording layer recess depth Tg in the groove area 75, resides in Tg<Tpb<Tp, because the recording layer recess depth Tpb in the boundary pit area 74 reduces the difference between the recording layer recess depth Tg in the groove area 75 and the recording layer recess depth Tp in the in-groove pit area 73. Further, it is desirable that the ratio of the maximum depth dp of the in-groove pit portion to the maximum depth dg of the groove portion and the ratio of the recording layer recess depth Tp to the recording layer recess depth Tg satisfy the condition of dp/dg<Tp/Tg. Even when the maximum depth dp of the in-groove pit does not satisfy the. condition to obtain the sufficient degree of signal modulation and the radial push-pull signal with respect to the maximum depth dg of the groove portion, then the difference between the optical path length of the laser beam at the groove portion and the optical path length of the laser beam at the in-groove pit portion is magnified during the reproduction of recorded information by applying the dye material as the recording layer onto the substrate, and it is possible to increase the difference in optical path length. Accordingly, it is possible to obtain the sufficient degree of signal modulation and the radial push-pull signal.

A recording signal recorded in the in-groove pit area was reproduced on the optical information-recording medium obtained in the embodiment described above by using an optical pickup with a laser beam having a wavelength of 650 nm and a lens having a numerical aperture of 0.6. The detection and the reproduction of the signal were successfully performed in a stable manner. In this procedure, the degree of signal modulation of the reproduced signal was 61%, and the jitter was 7.2%. Satisfactory results were successfully obtained in any case.

This embodiment has been explained as exemplified by the area in which the in-groove pit 73a and the boundary pit 74a are adjacent to one another, as shown in FIG. 8A. However, even when the tracking is performed in the area in which the in-groove pit and the groove portion in the boundary pit area are adjacent to one another, no tracking error occurs for the following reason. In addition to the fact that the light spot has a spot size to a certain extent, the light spot is subjected to the scanning during the actual tracking in the direction which is not perpendicular to the tracking direction but which forms a gentle angle with respect to the tracking direction. Therefore, when the boundary pit area is subjected to the tracking, any boundary pit portion enters the light spot. Accordingly, the radial push-pull signal, which is obtained from the boundary pit area, is averaged. It is possible to suppress the disturbance of the radial push-pull signal between the in-groove pit area and the groove area during the tracking as compared with an optical information-recording medium on which only the groove and the in-groove pits are formed.

### COMPARATIVE EXAMPLE 1

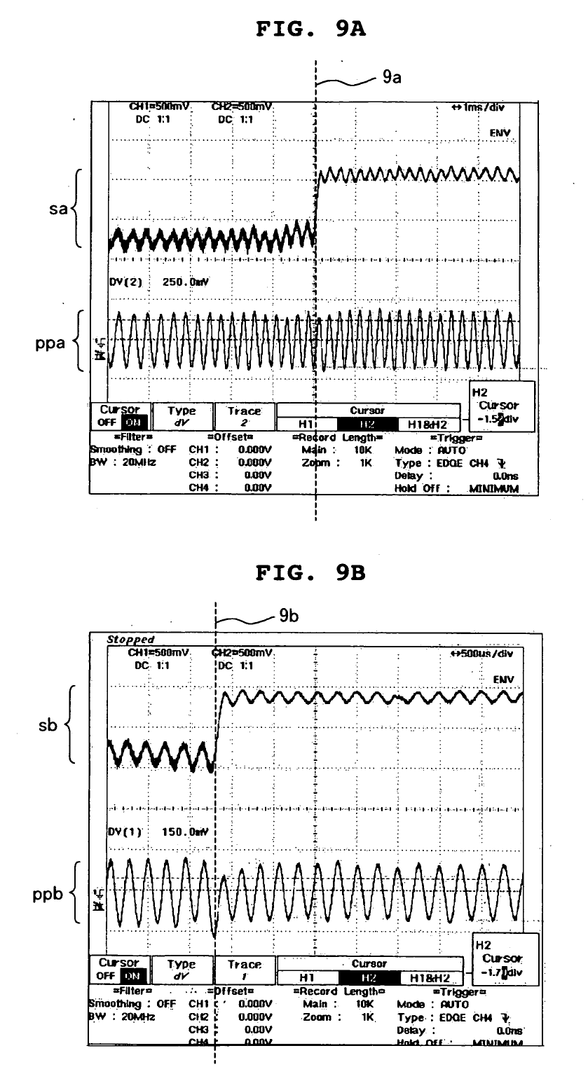

Next, a description will be made about a result of comparison between the radial push-pull signal output of the optical information-recording medium manufactured in the embodiment described above and the radial push-pull signal output of an information-recording medium having conventional in-groove pits. FIG. 9A shows a result of the detection from the optical information-recording medium manufactured in the embodiment described above, wherein the upper part depicts the output of the sum signal sa from a two-division detector of an optical pickup during the seek, and the lower part depicts the output of the difference signal (radial push-pull signal) ppa. FIG. 9B shows a result of the detection from the optical information-recording medium having the conventional in-groove pits, wherein the upper part depicts the output of the sum signal sb during the seek, and the lower part depicts the output of the difference signal (radial push-pull signal) ppb respectively. In both of FIGS. 9A and 9B, the portion, at which the amplitude level of the sum signal sa, sb is greatly changed (portions indicated by the symbol 9a in FIG. 9A and indicated by the symbol 9b in FIG. 9B respectively), is the boundary between the in-groove pit area and the groove area. The disturbance of the difference signal (radial push-pull signal) ppa depicted in the lower part is scarcely observed at the position corresponding to the symbol 9a in FIG. 9A, i.e., at the boundary between the in-groove pit area and the groove area of the optical information-recording medium of the embodiment described above. On the other hand, the large disturbance of the difference signal (radial push-pull signal) ppb depicted in the lower part has been successfully confirmed at the position corresponding to the symbol 9b in FIG. 9B, i.e., at the boundary between the in-groove pit area and the groove area of the optical information-recording medium having the conventional in-groove pits. As described above, the tracking is performed by utilizing the radial push-pull signal on DVD-R and DVD-RW. If the amplitude balance of the radial push-pull signal is collapsed, i.e., if the amplitude center is deviated at the boundary between the in-groove pit area and the groove area, then the tracking error tends to appear.

In the case of the optical information-recording medium manufactured in the embodiment described above, the amount of variation between the radial push-pull signal obtained from the groove portion and the radial push-pull signal obtained from the in-groove pit portion is 36% provided that the amplitude of the radial push-pull signal obtained in the normal state is 100%. Although not specifically prescribed in the DVD-R standards, it is prescribed in the DVD-RW standards that the amount of variation between the radial push-pull signal obtained from the groove portion and the radial push-pull signal obtained from the prepit portion is not less than 20%. Therefore, the optical information-recording medium of the embodiment described above sufficiently satisfies the standard, which does not cause any tracking deviation (tracking error). On the contrary, in the case of the optical information-recording medium having the conventional in-groove pits, the amount of variation is about 18 to 20%. Therefore, the optical information-recording medium having the conventional in-groove pits is equivalent or inferior to the lower limit value of the standard of DVD-RW, in which the tracking deviation (tracking error) is apt to occur.

In the case of the optical information-recording medium of the embodiment described above, polycarbonate is used for the substrate. However, for example, polymethyl methacrylate or amorphous polyolefin may be used. In the case of the optical information-recording medium of the embodiment described above, the respective layers are formed on the substrate in the order of the recording layer and the reflective layer. However, the respective layers may be formed by firstly forming the reflective layer on the pattern formation surface of the substrate and then forming the recording layer on the reflective layer. Even when the optical information-recording medium is manufactured in accordance with the layer arrangement as described above, it is possible to obtain the same effects as those obtained in the embodiment described above.

### Second Embodiment

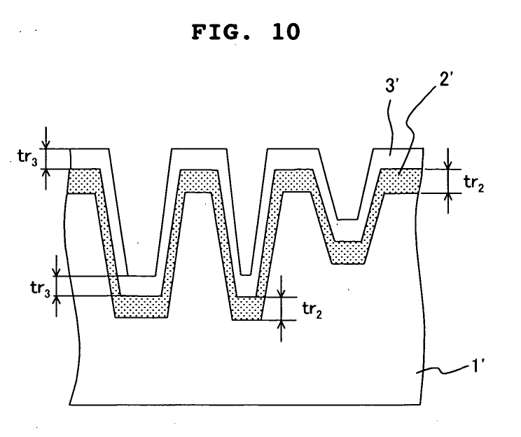

Another embodiment of the optical information-recording medium according to the present invention will be explained with reference to FIG. 10. The optical information-recording medium of this embodiment was constructed in the same manner as in the first embodiment except that tellurium (Te) was used as a metal material for a recording layer. Information is recorded and reproduced in the recording layer based on AgInSbTe. As shown in FIG. 10, the metal material containing Te was formed as the recording layer 2′ having a thickness of 15 nm on a substrate 1′ formed with the land, the groove, and the in-groove pits by using the sputtering method. Further, the Ag alloy was formed to have a thickness of 160 nm on the recording layer 2′ by using the sputtering method in the same manner as in the first embodiment. Accordingly, a reflective layer 3′ was obtained. When AgInSbTe is used as the material for the recording layer 2′, the thickness tr₂ of the recording layer 2′ stacked on the pattern formation surface of the substrate 1′ is substantially constant irrelevant to the places. The thickness tr₃ of the reflective layer 3′ stacked on the recording layer 2′ is also substantially constant irrelevant to the places. Therefore, it is easy to grasp the thicknesses of the recording layer and the reflective layer in the respective areas of the medium. It is possible to control the thickness of the layer to be stacked on the basis of the information thereon. Accordingly, it is possible to form the layers of the optical information-recording medium more stably.

### Third Embodiment

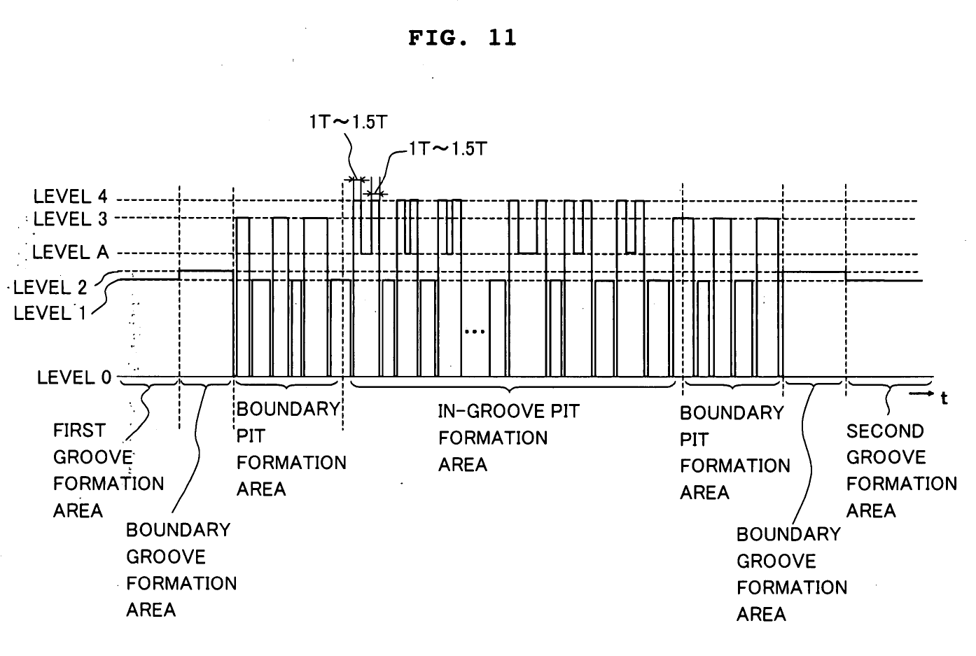

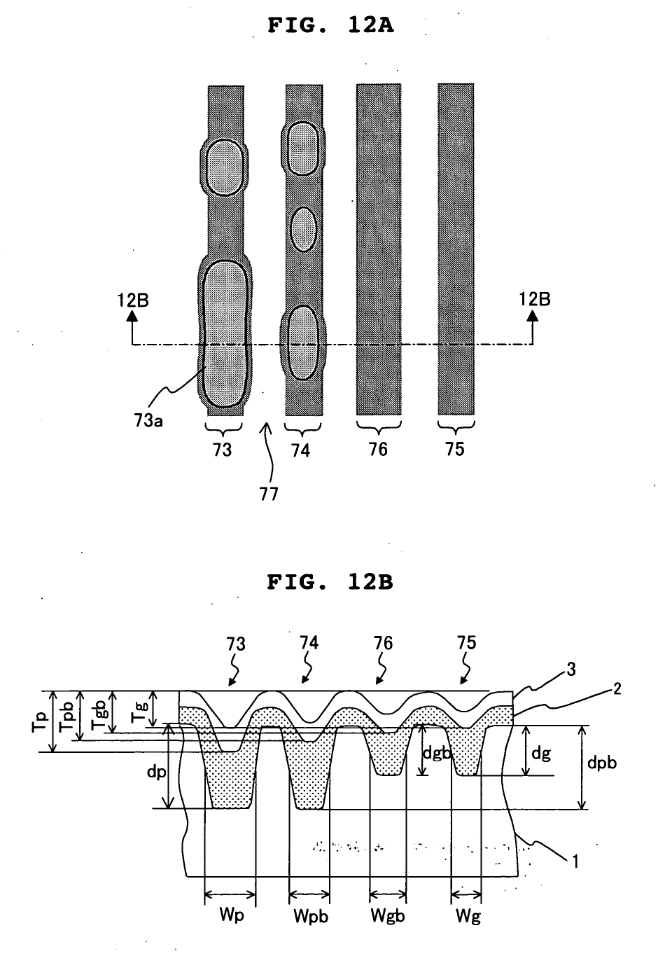

Another embodiment of the present invention will be explained with reference to FIGS. 11 and 12. This embodiment was constructed in the same manner as the first embodiment.except that grooves (hereinafter referred to as “boundary grooves”), which had widths wider than those of the grooves in the groove areas, were formed in an amount corresponding to 1 track between the groove areas and the boundary pit area of a substrate to be used for the optical information-recording medium. An explanation will be made below about methods for manufacturing a master disk and a stamper used to manufacture the substrate, and the optical information-recording medium.

In this embodiment, the exposure intensity of the laser beam to be radiated onto the glass master disk is changed by using the optical modulator while moving the laser beam on the glass master disk in the same manner as in the first embodiment. In this embodiment, as shown in FIG. 11, the exposure intensity of the laser beam was changed at four levels, i.e., the level 1, the level 2, the level 3, and the level 4 as ordered from lower levels to higher levels. The ratios of the respective levels were set as follows in this embodiment. That is, the level 3 was set to 90%, the level 2 was set to 60%, and the level. 1 was set to 55% provided that the level 4 was 100%. As shown in FIG. 11, the exposure intensity was set to the level 1 for the first and second groove formation areas. In the in-groove pit formation area, the exposure intensity was set to the level 4 for the in-groove pit formation portion, and the exposure intensity was set to the level 1 for the groove portion other than the above. The exposure intensity was set to the level 2 for the groove formation portions in the boundary groove formation areas. In the boundary pit formation areas, the exposure intensity was set to the level 3 for the in-groove pit formation portions, and the exposure intensity was set to the level 1 for the groove portions other than the above. In the case of the optical information-recording medium of this embodiment, the groove width is changed gently over the range ranging from the boundary groove area to the boundary pit area, even when the pits, which are formed in the boundary pit area, are formed to be large as compared with the first embodiment. Therefore, the radial push-pull signal is hardly offset and disturbed. Accordingly, it is possible to obtain a sufficient degree of modulation even in the case of the in-groove pits formed in the boundary pit area. Therefore, the pattern of the in-groove pits, which is formed in the boundary pit area, is not limited to the random pattern such as the dummy, which may be a recording signal pattern of user information. Accordingly, the pattern of the in-groove pit formation portion in the boundary pit formation area of the master disk is formed as the pattern corresponding to the in-groove pits as described above.

Subsequently, the glass master disk, on which the photoresist had been photosensitized, was subjected to the development treatment in the same manner as in the first embodiment. The glass master disk was subjected to the etching in accordance with the remaining photoresist pattern by using, for example, the RIE apparatus. Accordingly, the glass master disk, which had a desired concave/convex pattern formed on the surface, was obtained. In this embodiment, the groove formation section and the boundary groove formation section were etched until arrival at a depth of 170 nm from the glass master disk surface. The in-groove pit formation section and the boundary pit formation section were etched until arrival at a depth of 260 nm from the glass master disk surface. The boundary groove formation section was formed to be wide as compared with the groove formation section.

In this embodiment, when the exposure intensity was changed during the exposure, the period, in which the exposure intensity of the laser beam was temporarily at the 0 level, was provided every time when the exposure intensity was switched in the same manner as in the first embodiment. Further, in this embodiment, the master disk was subjected to the exposure while controlling the exposure intensity as follows for the respective in-groove pit formation portions having predetermined pit lengths in the in-groove pit formation area. As shown in FIG. 11, the exposure was performed at the level 4 during a period of 1 T to 1.5 T (T: clock cycle) from the start of the exposure. Subsequently, the exposure was performed during a predetermined period while lowering the exposure intensity to a level (level A) of 70% of the level 4. Further, the exposure was performed while returning the exposure intensity to the level 4 again during a period of 1 T to 1.5 T until arrival at the end of the in-groove pit formation portion. Accordingly, the width in the radial direction of the master disk of each of the in-groove pit formation portions is prevented from being widened at positions in the vicinity of the intermediate portion in the track direction of the in-groove pit formation portion. The exposure intensity may be similarly controlled for the exposure intensity for the in-groove pit formation portion in the boundary pit formation area.

The stamper was manufactured by using the master disk obtained as described above, and the substrate was manufactured by using the injection molding method in the same manner as in the first embodiment. Subsequently, as shown in FIG. 12B, the recording layer 2 and the reflective layer 3 were formed in the same manner as in the first embodiment. The dummy substrate was stuck to the obtained substrate by the aid of the photocurable resin. Thus, the optical information-recording medium was obtained.

The maximum depths of the in-groove pit portion in the in-groove pit area 73, the boundary pit portion in the boundary pit area 74, the groove portion in the boundary groove area 76, and the groove portion in the groove area 75 of the optical information-recording medium obtained as described above were measured by using AFM produced by Digital Instruments in the same manner as in the first embodiment. As shown in FIG. 12B, the maximum depth dg of the groove portion was 170 nm. The maximum depth dgb of the boundary groove portion was 170 nm. The maximum depth dpb of the boundary pit portion was 260 nm. The maximum depth dp of the in-groove pit portion was 260 nm. It is desirable that the maximum depth dg of the groove portion and the maximum depth dp of the in-groove pit portion satisfy the condition of 1.4≦dp/dg≦1.7 in order to obtain the satisfactory recording and reproduction signal characteristics such as those concerning the degree of signal modulation and the jitter.

The half value width Wp of the in-groove pit portion in the in-groove pit area 73, the half value width Wpb of the boundary pit portion in the boundary pit area 74, the half value width Wgb of the groove portion in the boundary groove area 76, and the half value width Wg of the groove portion in the groove area 75 were measured respectively on the basis of the surface of the land 80 by using AFM produced by Digital Instruments. The half value width Wg was 320 nm, the half value width Wgb was 330 nm, the half value width Wpb was 360 nm, and the half value width Wp was 400 nm. Accordingly, it is appreciated that the relationship of Wg≦Wgb≦Wpb<Wp holds. Further, it is appreciated that the ratio Wp/Wpb=1.11 is established between the half value width Wp and the half value width Wpb, and the condition of 1.05≦Wp/Wpb≦1.15 is satisfied. Further, it is appreciated that the ratio Wgb/Wg=1.03 is established between the half value width Wgb and the half value width Wg, and the condition of 1.03≦Wgb/Wg≦1.15 is satisfied.

In the optical information-recording medium obtained in this embodiment, as shown in FIG. 12A, the width is suppressed from being widened in the radial direction of the substrate at portions in the vicinity of the middle portion in the track direction of the in-groove pit 73a in the in-groove pit area 73, as a result of the exposure performed in accordance with the exposure schedule as described above. Accordingly, the land surface, which has a sufficient areal size, can be secured at the land portion 77 adjacent to the in-groove pit as well. Thus, it is possible to obtain a stable radial push-pull signal from the optical information-recording medium.

In order to adjust the effect to suppress the width of the in-groove pit 73a from being widened, a scanning probe microscope produced by Digital Instruments was used to measure the width in the radial direction of the substrate of the in-groove pit having the shortest channel bit length 3 T and the widths in the radial direction of the substrate of the in-groove pits having the channel bit lengths longer than the above respectively in the in-groove pit area 73. The maximum width of the in-groove pit having the shortest channel bit length 3 T was 0.34 μm. The maximum width of the in-groove pit having the channel bit length of 11 T was 0.38 μm. Further, the maximum width of the in-groove pit having the channel bit length of 14 T was 0.4 μm. According to the experiment performed by the present inventors, the ratio of the maximum width of the in-groove pit having the channel bit length longer than the shortest channel bit length 3 T with respect to the maximum width of the in-groove pit having the shortest channel bit length 3 T was within a range of 112 to 118%. It is appreciated that the width is suppressed from being widened in the radial direction of the substrate in the in-groove pits having the lengths longer than the shortest channel bit length.

The recording layer recess depths of the in-groove pit portion in the in-groove pit area 73, the boundary pit portion in the boundary pit area 74, and the groove portions in the boundary groove area 76 and the groove area 75 of the obtained optical information-recording medium were measured by using AFM produced by Digital Instruments in the same manner as in the first embodiment. As shown in FIG. 12B, the recording layer recess depth Tp in the in-groove pit area 73 was 170 nm. The recording layer recess depth Tpb in the boundary pit area 74 was 135 nm. The recording layer recess depth Tgb in the boundary groove area 76 was 110 nm. Further, the recording layer recess depth Tg in the groove area 75 was 100 nm. It is desirable that the recording layer recess depth Tp and the recording layer recess depth Tg satisfy the condition of 1.6≦Tp/Tg≦2.0 in order to obtain the satisfactory recording and reproduction signal characteristics such as those concerning the degree of signal modulation and the jitter in the same manner as in the first embodiment.

The relationship, which holds for the recording layer recess depth Tpb in the boundary pit area 74, the recording layer recess depth Tp in the in-groove pit area 73, the recording layer recess depth Tgb in the boundary groove area 76, and the recording layer recess depth Tg in the groove area 75, resides in Tg<Tgb<Tpb<Tp, in view of the relationship among the groove half value widths in the respective areas described above.

A recording signal recorded in the in-groove pit area was reproduced on the optical information-recording medium obtained in the embodiment described above by using an optical pickup with a laser beam having a wavelength of 650 nm and a lens having a numerical aperture of 0.6. The detection and the reproduction of the signal were successfully performed in a stable manner. In this procedure, the degree of signal modulation of the reproduced signal was 61%, and the jitter was 7.2%. Satisfactory results were successfully obtained in any case.

### Fourth Embodiment

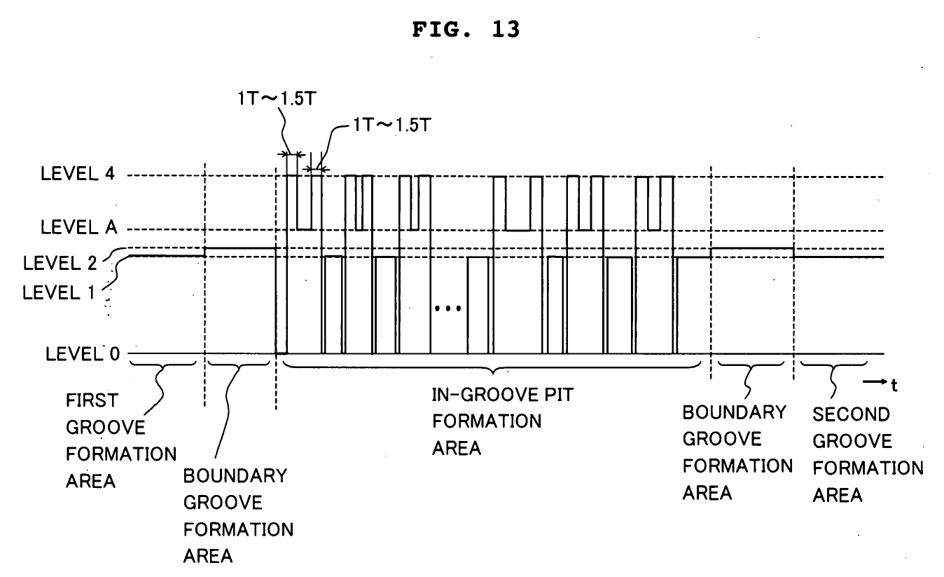

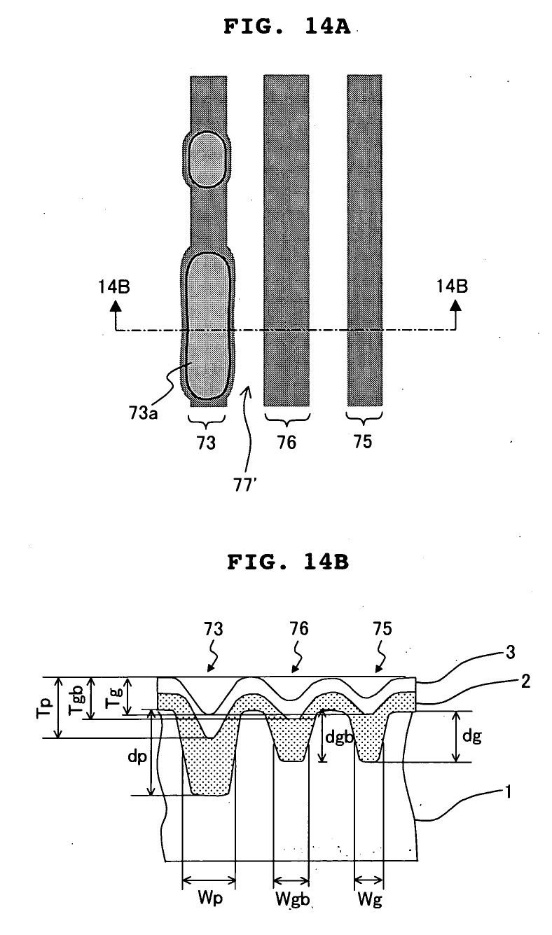

Still another embodiment of the present invention will be explained with reference to FIGS. 13 and 14. This embodiment was constructed in the same manner as the third embodiment except that the boundary pit areas to be used for an optical information-recording medium were not provided, and only the boundary groove areas were formed between the groove areas and the in-groove pit formation area. An explanation will be made below about methods for manufacturing a master disk and a stamper used to manufacture a substrate, and the optical information-recording medium.

In this embodiment, as shown in FIG. 13, the exposure was performed for the master disk by using the exposure intensities of the laser beam at the three levels of the level 1, the level 2, and the level 4 of the exposure intensities used in the third embodiment. The ratios of the respective levels in this embodiment were set in the same manner as in the third embodiment. That is, the level 2 was 60% and the level 1 was 55% provided that the level 4 was 100%. As shown in FIG. 13, the exposure intensity was set to the level 1 for the first and second groove formation areas. In the in-groove pit formation area, the exposure intensity was set to the level 4 for the in-groove pit formation portion, and the exposure intensity was set to the level 1 for the groove portion other than the above. In the boundary groove formation areas, the exposure intensity was set to the level 2 for the groove formation portions.

Subsequently, the glass master disk, on which the photoresist had been photosensitized, was subjected to the development treatment in the same manner as in the first embodiment. The glass master disk was subjected to the etching in accordance with the remaining photoresist pattern by using, for example, the RIE apparatus. Accordingly, the glass master disk, which had a desired concave/convex pattern formed on the surface, was obtained. In this embodiment, the groove formation section and the boundary groove formation section were etched until arrival at a depth of 170 nm from the glass master disk surface. The in-groove pit formation section was etched until arrival at a depth of 260 nm from the glass master disk surface. The boundary groove formation section was formed to be wider than the groove formation section.

In this embodiment, when the exposure intensity was changed during the exposure, the period, in which the exposure intensity of the laser beam was temporarily at the 0 level, was provided every time when the exposure intensity was switched in the same manner as in the third embodiment. Further, as shown in FIG. 13, the master disk was subjected to the exposure while controlling the exposure intensity for the respective in-groove pit formation portions having the predetermined pit lengths in the in-groove pit formation area in the same manner as in the third embodiment.

The substrate was manufactured with the master disk obtained as described above by using the injection molding method in the same manner as in the third embodiment. Subsequently, as shown in FIG. 14B, a recording layer 2 and a reflective layer 3 were formed in the same manner as in the third embodiment. The dummy substrate was stuck to the obtained substrate by the aid of the photocurable resin. Thus, the optical information-recording medium was obtained.

The maximum depths of the in-groove pit portion in the in-groove pit area 73, the groove portion in the boundary groove area 76, and the groove portion in the groove area 75 of the optical information-recording medium obtained as described above were measured by using AFM produced by Digital Instruments in the same manner as in the third embodiment. As shown in FIG. 14B, the maximum depth dg of the groove portion was 170 nm. The maximum depth dgb of the boundary groove portion was 170 nm. The maximum depth dp of the in-groove pit portion was 260 nm. It is desirable that the maximum depth dg of the groove portion and the maximum depth dp of the in-groove pit portion satisfy the condition of 1.4≦dp/dg≦1.7 in order to obtain the satisfactory recording and reproduction signal characteristics such as those concerning the degree of signal modulation and the jitter.

The half value width Wp of the in-groove pit portion in the in-groove pit area 73, the half value width Wgb of the groove portion in the boundary groove area 76, and the half value width Wg of the groove portion in the groove area 75 were measured respectively on the basis of the surface of the land 80 by using AFM produced by Digital Instruments. The half value width Wg was 320 nm, the half value width Wgb was 350 nm, and the half value width Wp was 400 nm. Accordingly, it is appreciated that the relationship of Wg<Wgb≦Wp holds. Further, it is appreciated that the ratio Wgb/Wg=1.09 is established between the half value width Wgb and the half value width Wg, and the condition of 1.05≦Wgb/Wg≦1.15 is satisfied.

As shown in FIG. 14A, the width is suppressed from being widened in the radial direction of the substrate at portions in the vicinity of the middle portion in the track direction of the in-groove pit 73a in the in-groove pit area 73, as a result of the exposure performed in accordance with the exposure schedule as described above. Accordingly, the land surface, which has a sufficient areal size, can be secured at the land portion 77′ adjacent to the in-groove pit as well. Thus, it is possible to obtain a stable radial push-pull signal from the optical information-recording medium.

In order to adjust the effect to suppress the width of the in-groove pit 73a from being widened, a scanning probe microscope produced by Digital Instruments was used to measure the width in the radial direction of the substrate of the in-groove pit having the shortest channel bit length 3 T and the widths in the radial direction of the substrate of the in-groove pits having the channel bit lengths longer than the above respectively in the in-groove pit area 73. The maximum width of the in-groove pit having the shortest channel bit length 3 T was 0.34 μm. The maximum width of the in-groove pit having the channel bit length of 11 T was 0.38 μm. Further, the maximum width of the in-groove pit having the channel bit length of 14 T was 0.4 μm. According to the experiment performed by the present inventors, the ratio of the maximum width of the in-groove pit having the channel bit length longer than the shortest channel bit length 3 T with respect to the maximum width of the in-groove pit having the shortest channel bit length 3 T was within a range of 100% to 118% and preferably within a range of 112 to 118%. It is appreciated that the width is suppressed from being widened in the radial direction of the substrate in the in-groove pits having the lengths longer than the shortest channel bit length.

The recording layer recess depths of the ingroove pit portion in the in-groove pit area 73 and the groove portions in the boundary groove area 76 and the groove area 75 of the obtained optical information-recording medium were measured by using AFM produced by Digital Instruments in the same manner as in the third embodiment. As shown in FIG. 14B, the recording layer recess depth Tp in the in-groove pit area 73 was 170 nm. The recording layer recess depth Tgb in the boundary groove area 76 was 120 nm. Further, the recording layer recess depth Tg in the groove area 75 was 100 nm. It is desirable that the recording layer recess depth Tp and the recording layer recess depth Tg satisfy the condition of 1.6≦Tp/Tg≦2.0 in order to obtain the satisfactory recording and reproduction signal characteristics such as those concerning the degree of signal modulation and the jitter in the same manner as in the first embodiment.

The relationship, which holds for the recording layer recess depth Tp in the in-groove pit area 73, the recording layer recess depth Tgb in the boundary groove area 76, and the recording layer recess depth Tg in the groove area 75, resides in Tg<Tgb<Tp, in view of the relationship among the groove half value widths of the respective areas described above.

A recording signal recorded in the in-groove pit area was reproduced on the optical information-recording medium obtained in the embodiment described above by using an optical pickup with a laser beam having a wavelength of 650 nm and a lens having a numerical aperture of 0.6. The detection and the reproduction of the signal were successfully performed in a stable manner. In this procedure, the degree of signal modulation of the reproduced signal was 61%, and the jitter was 7.2%. Satisfactory results were successfully obtained in any case.

The exposure intensity has been controlled for the in-groove pit formation portion having the predetermined pit length in the in-groove pit formation area during the exposure of the master disk in each of the third and fourth embodiments such that the first exposure intensity is firstly used, the second exposure intensity, which is lower than the first exposure intensity, is subsequently used, and the exposure intensity is changed to the first exposure intensity. However, the exposure intensity may be also controlled in the same manner as described above during the exposure of the master disk in each of the first and second embodiments.

### Fifth Embodiment

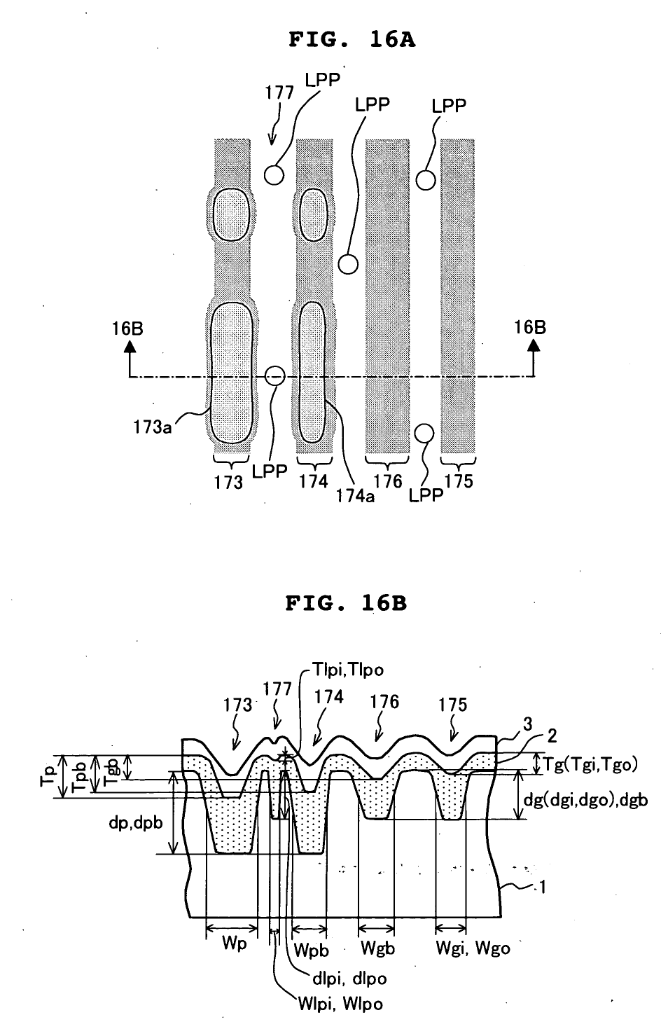

A fifth embodiment of the present invention will be explained with reference to FIGS. 16 to 19. As shown in FIG. 16, an optical information-recording medium of this embodiment was constructed in the same manner as in the third embodiment except that land prepits LPP were formed at predetermined intervals in the track direction on the land portion of a substrate 1, grooves except for those in the boundary groove areas 176 were formed so that the grooves were continuously deepened and widened in the direction from the inner circumference (inner side) to the outer circumference (outer side) of the substrate, and the land prepits LPP were formed so that the land prepits LPP were continuously deepened and widened in the direction from the inner circumference to the outer circumference of the substrate. The land prepits LPP are used to previously record, for example, position information of the medium on the optical information-recording medium. An explanation will be made below about methods for manufacturing a master disk and a stamper used to manufacture the substrate, and the optical information-recording medium.

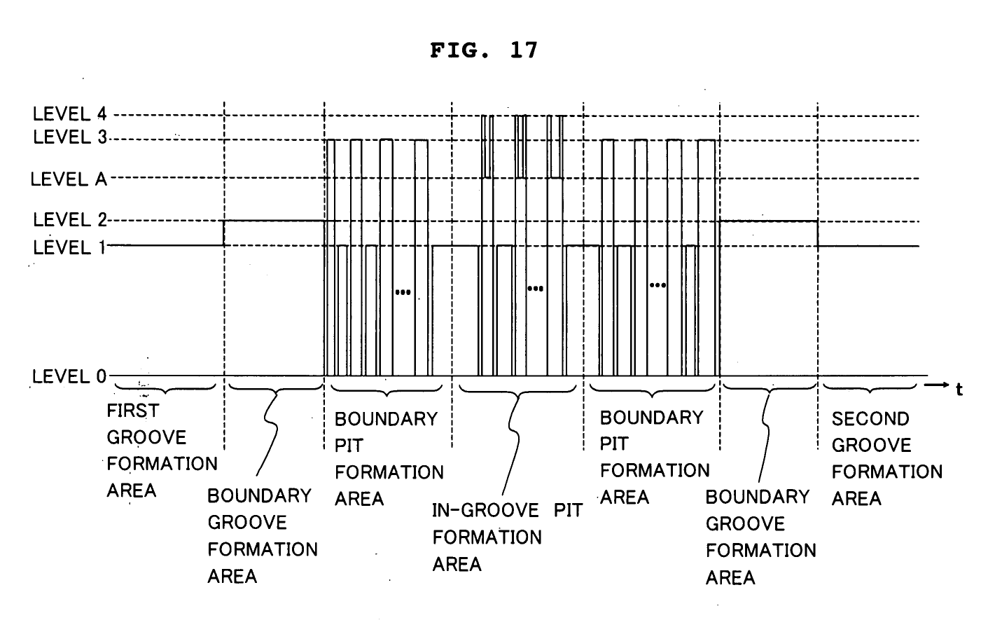

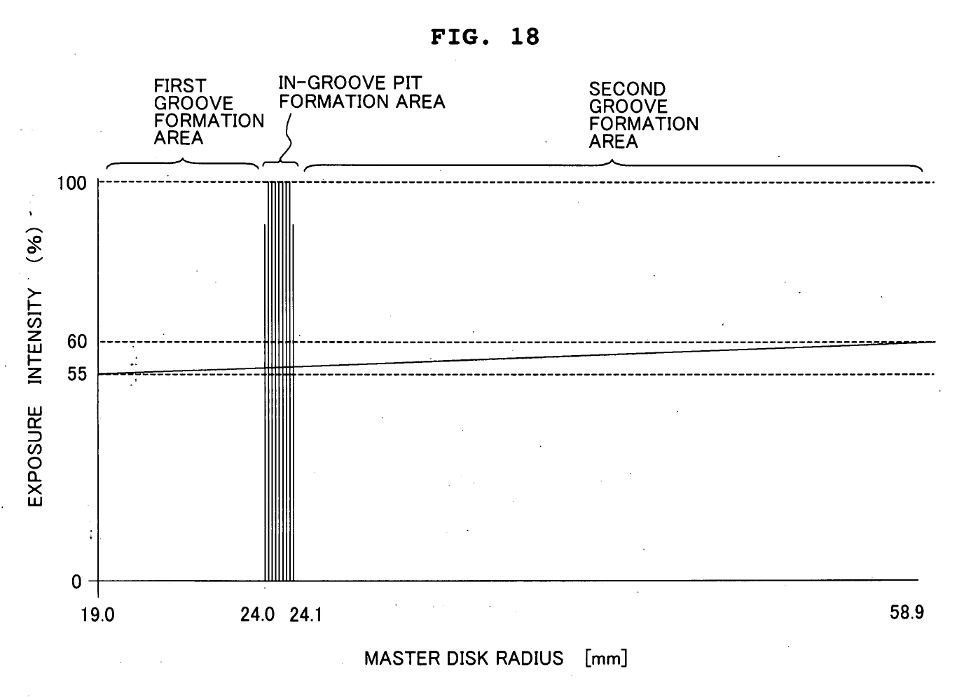

FIG. 17 shows the change of the exposure intensity of the laser beam in the vicinity of the in-groove pit formation area of the glass master disk. FIG. 18 shows the change of the exposure intensity of the laser beam over the entire glass master disk. In this embodiment, as shown in FIG. 17, the four levels, i.e., the level 1, the level 2, the level 3, and the level 4 of the exposure intensity used in the third embodiment were used for the exposure intensity of the laser beam. Further, as shown in FIG. 18, the exposure intensity at the level 1, i.e., at the groove level was continuously changed in the direction from the inner circumference to the outer circumference of the glass master disk to perform the exposure for the master disk. In this embodiment, the following ratios of the respective levels were adopted. That is, the level 2 was set to 60% and the level 3 was set to 90% provided that the level 4 was 100%. As shown in FIG. 18, the level 1 was continuously changed so that the ratio was 55% at the exposure start position of the glass master disk (position of a radius of 19.0 mm from the center of the glass master disk) and the ratio was 60% at the exposure end position (position of a radius of 58.9 mm from the center of the glass master disk). When the exposure intensity of the groove level is changed so that the exposure intensity is continuously intensified as described above, a pattern corresponding to the groove can be formed on the glass master disk so that the width of the. pattern corresponding to the groove is continuously widened in the direction from the inner side to the outer side of the glass master disk.

As shown in FIG. 17, the exposure intensity was set to the level 1 for the first and second groove formation areas respectively. In the in-groove pit formation area, the exposure intensity was set to the level 4 for the in-groove pit formation portion, and the exposure intensity was set to the level 1 for the groove portion other than the above. The exposure intensity was set to the level 2 for the groove formation portions in the boundary groove formation areas. In the boundary pit formation areas, the exposure intensity was set to the level 3 for the in-groove pit formation portions, and the exposure intensity was set to the level 1 for the groove portions other than the above. Also in this embodiment, the control was made as follows to perform the exposure for the master disk in the same manner as in the third embodiment. That is, when the exposure intensity was changed during the exposure, the period, in which the exposure intensity of the laser beam was temporarily at the 0 level, was provided every time when the exposure intensity was switched. Further, the exposure intensity was temporarily lowered (to the level A) for the respective in-groove pit formation portions having the predetermined pit lengths in the in-groove pit formation area. In this embodiment, the ratio of the exposure intensity level A was 75%.

Although not shown, when the portion (hereinafter referred to as “land prepit formation portion”) corresponding to the land prepit formed on the land of the substrate was subjected to the exposure, the exposure intensity of the laser beam was adjusted in the same manner as in the method for controlling the exposure intensity described above so that the depth of the land prepit was substantially the same as the depth of the adjoining groove and the groove width was continuously widened in the direction from the inner circumference to the outer circumference of the substrate. The land prepit formation portion was subjected to the exposure by using a laser beam which was different from the laser beam to be used for the exposure, for example, for the groove formation portion and the in-groove pit formation portion.

Subsequently, the glass master disk, on which the photoresist had been photosensitized, was subjected to the development treatment in the same manner as in the third embodiment. The glass master disk was subjected to the etching by using the RIE apparatus and the ashing apparatus in accordance with the pattern of the remaining photoresist. Accordingly, the glass master disk (not shown), on which a desired concave/convex pattern was formed on the surface, was obtained. In this embodiment, the RIE apparatus was controlled as follows in order to form the groove so that the depth was uniform in the track direction and the depth was continuously deepened in the direction from the inner circumference to the outer circumference of the glass master disk.

Method for Controlling RIE Apparatus

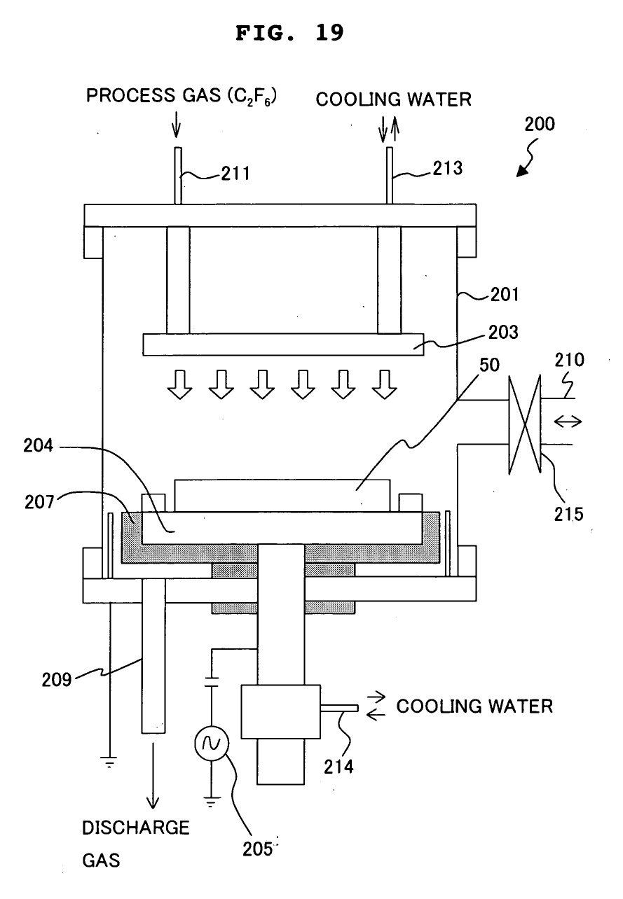

FIG. 19 schematically shows the RIE apparatus. The RIE apparatus 200 principally comprises a closable chamber 201, an anode 203, a cathode 204, an RF power source 205, an insulator section 207, discharge tubes 209, 210, a gas supply tube 211, and cooling water supply tubes 213, 214. The anode 203 is installed at an upper position in the chamber 201 together with the gas supply tube 211 and the cooling water supply tube 213. The cathode 204 is installed at a lower position in the chamber 201 together with the intervening insulator section 207. The master disk, which is the etching objective, is placed on the upper surface of the cathode 204. The discharge tube 209 is provided through the lower surface of the chamber 201 so that the discharge tube 209 is communicated with the interior of the chamber 201. The discharge tube 210 is provided through the side wall of the chamber 201 so that the discharge tube 210 is communicated with the interior of the chamber 201. A gate valve 215, which is provided at an intermediate position of the discharge tube 210, makes it possible to regulate the pressure in the chamber 201.

At first, a predetermined amount of process gas (C₂F₆) is supplied into the chamber 201 via the gas supply tube 211 from an unillustrated gas supply unit installed on the side of the anode 203 of the RIE apparatus 200. During this operation, any excessive process gas is discharged through the discharge tube 209 so that the pressure in the chamber 201 is always constant. When the electric power is applied to the cathode 204 with the RF power source 205 in a state in which the interior of the chamber 201 is filled with the process gas, then the interior of the chamber 201 is in a plasma state, and the glass master disk 50, which is formed with the photoresist layer having the surface subjected to the patterning, is etched.

In general, in RIE, it is known that the faster the flow of the gas in the chamber is, the more increased the etching rate is. As a result of investigations performed by the present inventors while variously changing the conditions of the gas flow rate, the pressure, and the applied electric power in RIE, it has been revealed that the pressure in the chamber is especially greatly relevant in order to generate the difference between the groove depth formed on the inner side and the groove depth formed on the outer side of the master disk. As the pressure in the chamber is set to be high, the difference appears between the outer side and the inner side in relation to the gas flow rate flowing in the chamber of the RIE apparatus. Accordingly, when the position is nearer to the center in the chamber, the gas flow rate is decreased, i.e., the flow of the gas is slow. When the position is nearer to the inner wall of the chamber, the gas flow rate is increased, i.e., the flow of the gas is fast. Therefore, the etching rate is increased at positions nearer to the outer side of the glass master disk. Thus, the groove is formed, which is continuously deepened in the direction from the inner side to the outer side of the glass master disk.

In this embodiment, the gas flow rate and the applied electric power of the RIE apparatus were fixed, and only the pressure was variously changed from the reference of the conventional pressure (condition 1) to twice the conventional pressure (condition 2), four times the conventional pressure (condition 3), eight times the conventional pressure (condition 4), and sixteen times the conventional pressure (condition 5) to etch the glass master disk so that the comparison was made about the difference between the inner side and the outer side in relation to the depth of the groove formed on the glass master disk. An obtained result is shown in Table 1. Table 1 also shows, in combination, the stability of the plasma under the respective conditions. The stability of the plasma is based on the investigation about the presence or absence of, for example, the flicker and the electric discharge of the plasma during the etching. In Table 1, the symbol “+” indicates the level of no problem. The symbol “−” indicates the level at which the stability of the electric discharge is deficient and it is considered to be difficult that the master disk is processed in a reproducible manner. The symbol “±” indicates the intermediate level therebetween. According to the result shown in Table 1, it is appreciated that the difference in groove depth between the inner side and the outer side of the master disk is increased as the pressure in the chamber is set to be high, but the stability of the plasma in the chamber is deteriorated together therewith. In order to obtain a certain amount of the difference in groove depth while maintaining the stability of the plasma, it is preferable that the interior of the chamber is set to have the pressure of the condition 3, i.e., four times the conventional pressure. Accordingly, it is possible to obtained a difference in groove depth of about 10 nm between the inner side and the outer side.

TABLE 1

| | Condition 1 | Condition | Condition | Condition | Condition |
|---|---|---|---|---|---|
| Pressure | (conventional) | 2 | 3 | 4 | 5 |
| Differ- | 1.0 | 7.5 | 9.9 | 11.6 | 20.7 |
| ence in | | | | | |
| groove | | | | | |
| depth | | | | | |
| [nm] | | | | | |
| Stabil- | + | + | + | ± | − |
| ity of | | | | | |
| plasma | | | | | |

In this embodiment, the boundary groove formation section was subjected to the etching until arrival at a depth of 170 nm from the glass master disk surface, and the in-groove pit formation section and the boundary pit formation section were subjected to the etching until arrival at a depth of 250 nm from the glass master disk surface. The groove formation sections were subjected to the etching until arrival at a depth of 160 nm from the glass master disk surface at the inner circumferential portion (radius: 23.0 mm) of the glass master disk and at a depth of 170 nm from the glass master disk surface at the outer circumferential portion (radius: 58.7 mm) of the glass master disk. The land prepit formation portions were subjected to the etching until arrival at a depth of 160 nm from the glass master disk surface at the inner circumferential portion of the glass master disk and at a depth of 170 nm from the glass master disk surface at the outer circumferential portion of the glass master disk so that the groove depths were the same as those of the groove formation sections adjacent to the respective land prepit formation portions.

On this condition, the half depth value groove width of the groove formation section was 310 nm at the inner circumferential portion (radius: 23.0 mm) of the glass master disk and 330 nm at the outer circumferential portion (radius: 58.7 mm) of the glass master disk. The half depth value groove width of the boundary groove formation section was 330 mm, which was formed to be wide as compared with the width of the adjoining groove formation section. The width of the land prepit formation portion was 170 nm at the inner circumferential portion of the glass master disk and 200 nm at the outer circumferential portion of the glass master disk. On this condition, the length in the track direction (pit length) of the land prepit formation portion at the inner circumferential portion was 170 nm, and the length in the track direction (pit length) of the land prepit formation portion at the outer circumferential portion was 200 nm.

The substrate was manufactured with the master disk obtained as described above by using the injection molding method in the same manner as in the third embodiment. Subsequently, as shown in FIG. 16B, a recording layer 2 and a reflective layer 3 were formed in the same manner as in the third embodiment. The dummy substrate was stuck to the obtained substrate 1 by the aid of the photocurable resin, and thus the optical information-recording medium was obtained.

The maximum depths from the substrate surface (land surface) of the in-groove pit portion in the in-groove pit area, the boundary pit portion in the boundary pit area, and the groove portion in the boundary groove area of the optical information-recording medium, the maximum depths from the substrate surface of the groove portions at the inner circumferential portion (radius: 23.0 mm) and the outer circumferential portion (radius: 55.0 mm) in the groove area, and the maximum depths from the substrate surface of the land prepits at the inner circumferential portion (radius: 23.0 mm) and the outer circumferential portion (radius: 55.0 mm) were measured by using AFM produced by Digital Instruments. The maximum depth dgi of the inner circumferential groove portion was 155 nm. The maximum depth dgo of the outer circumferential groove portion was 165 nm. The ratio dgo/dgi=1.06 is established between the maximum depth dgi and the maximum depth dgo. It is appreciated that the condition of 1.00<dgo/dgi≦1.10 is satisfied. The maximum depth dgb of the boundary groove portion was 155 nm. The maximum depth dpb of the boundary pit portion was 245 nm. The maximum depth dp of the in-groove pit portion was 245 nm. It is desirable that the maximum depth dg (dgi≦dg≦dgo) of the groove portion and the maximum depth dp of the in-groove pit portion satisfy the condition of 1.4≦dp/dg≦1.7 in order to obtain the satisfactory recording and reproduction signal characteristics such as those concerning the degree of signal modulation and the jitter. The maximum depth dlpi of the inner circumferential land prepit was 155 nm, and the maximum depth dlpo of the outer circumferential land prepit was 165 nm. The maximum depths were substantially the same as the groove depths of the adjoining groove portions respectively. It is appreciated that both of the groove portion and the land prepit are formed such that the groove is deeper at the outer circumferential portion of the medium than at the inner circumferential portion of the medium.

The half value width Wp of the in-groove pit portion in the in-groove pit area, the half value width Wpb of the boundary pit portion in the boundary pit area, the half value width Wgb of the groove portion in the boundary groove area, the half value widths Wgi, Wgo of the groove portions at the inner circumferential portion and the outer circumferential portion in the groove area, and the bottom widths Wlpi, Wlpo of the land prepits at the inner circumferential portion (radius: 23.0 mm) and the outer circumferential portion (radius: 55.0 mm) were measured respectively on the basis of the surface of the land by using AFM produced by Digital Instruments. The half value width Wgi was 325 nm, the half value width Wgo was 345 nm, the half value width Wgb was 345 nm, the half value width Wpb was 350 nm, and the half value width Wp was 400 nm. Accordingly, it is appreciated that the relationship of Wgi<Wgo≦Wgb≦Wpb<Wp holds. Further, it is appreciated. that the ratio Wp/Wpb=1.14 is established between the half value width Wp and the half value width Wpb, and the condition of 1.05≦Wp/Wpb≦1.15 is satisfied. Further, it is appreciated that the ratio Wgo/Wgi=1.06 is established between the half value width Wgi and the half value width Wgo, and the condition of 1.03≦Wgo/Wgi≦1.10 is satisfied. The bottom widths Wlpi, Wlpo were 180 nm and 200 nm respectively. It is appreciated that the width of the land prepit is formed to be wider at the outer circumferential portion of the medium than at the inner circumferential portion of the medium.

As shown in FIG. 16A, in the case of the optical information-recording medium obtained in this embodiment, the width is suppressed from being widened in the radial direction of the substrate at portions in the vicinity of the middle portion in the track direction of the in-groove pit 173a in the in-groove pit area 173, as a result of the exposure performed in accordance with the exposure schedule as described above. Accordingly, the land surface, which has a sufficient areal size, is secured on the surface of the land portion 177 adjacent to the in-groove pit. Therefore, the land prepits LPP having the stable shapes can be formed on the surface of the land 177. Thus, it is possible to obtain a stable radial push-pull signal, and it is possible to reproduce the data recorded on the land prepits in a stable state.

The recording layer recess depths of the in-groove pit portion 173a in the in-groove pit area 173, the boundary pit portion 174a in the boundary pit area 174, and the groove portions in the boundary groove area 176 and the groove area 175, and the recording layer recess depth of the land prepit of the obtained optical information-recording medium were measured by using AFM produced by Digital Instruments. As shown in FIG. 16B, the recording layer recess depth Tp in the in-groove pit area 173 was 170 nm. The recording layer recess depth Tpb in the boundary pit area 174 was 135 nm. The recording layer recess depth Tgb in the boundary groove area 176 was 115 nm. Further, any one of the recording layer recess depth Tgi at the inner circumferential portion (radius: 23.0 mm) and the recording layer recess depth Tgo at the outer circumferential portion (radius: 55.0 mm) in the groove area 175 was 100 nm. It is desirable that the recording layer recess depth Tp and the recording layer recess depth Tg (=Tgi=Tgo) satisfy the condition of 1.6≦Tp/Tg≦2.0 in order to obtain the satisfactory recording and reproduction signal characteristics such as those concerning the degree of signal modulation and the jitter. Further, any one of the recording layer recess depth Tlpi at the inner circumferential portion (radius: 23.0 mm) and. the recording layer recess depth Tlpo at the outer circumferential portion (radius: 55.0 mm) of the Land prepit LPP was 100 nm.

The relationship, which holds for the recording layer recess depth Tpb of the boundary pit portion 174a, the recording layer recess depth Tp of the in-groove pit portion 173a, the recording layer recess depth Tgb in the boundary groove area 176, the recording layer recess depth Tgi of the inner circumferential portion in the groove area 175, and the recording layer recess depth Tgo of the outer circumferential portion in the groove area 175, resides in Tgi=Tgo<Tgb<Tpb<Tp, in view of the relationship among the half value widths of the grooves in the respective areas and the difference between the inner and outer circumferential portions in relation to the film thickness of the recording layer formed by the spin coat.

A recording signal recorded in the in-groove pit area was reproduced on the optical information-recording medium obtained in this embodiment by using an optical pickup with a laser beam having a wavelength of 650 nm and a lens having a numerical aperture of 0.6. The detection and the reproduction of the signal were successfully performed in a stable manner. In this operation, the degree of signal modulation of the reproduced signal was varied within a range of about 64 to 65%, and the jitter was varied within a range of about 7.8 to 7.5%. Satisfactory results were successfully obtained in any case. The reflectance variation between the inner and outer circumferential portions was less than 2% in the recording and reproducing area of the medium. The variation of the push-pull signal and the variation of the degree of modulation of the recording and reproducing signals, which would be otherwise caused by the reflectance variation, were successfully suppressed.

### COMPARATIVE EXAMPLE 2

Table 2 shown below is illustrative of the result of comparison of respective characteristics of the optical information-recording medium of the embodiment of the present invention (hereinafter referred to as “medium A”), an optical information-recording medium (hereinafter referred to as “medium B”) which is formed so that only the groove width of the groove is continuously widened in the direction from the inner circumference to the outer circumference of the optical information-recording medium, and an optical information-recording medium (hereinafter referred to as “medium C”) which is formed so that both of the groove depth and the groove width of the groove are uniform over the entire medium. As clarified from Table 2, the difference between the inner circumferential portion and the outer circumferential portion (amount of variation between the inner circumferential portion and the outer circumferential portion) of the medium A is small in any one of the characteristics of the optical information-recording medium as compared with the media B and C. That is, it is appreciated that the substantially equal or even characteristics are obtained irrelevant to the radial position on the medium.

TABLE 2

| | Medium A | | Medium B | | Medium C | |
|---|---|---|---|---|---|---|
| Radius (mm) | 25 | 55 | 25 | 55 | 25 | 55 |
| Reflectance (%) | 46.8 | 46.8 | 46.3 | 48.9 | 43.7 | 49.6 |
| Push-pull before | 0.370 | 0.340 | 0.325 | 0.254 | 0.350 | 0.246 |
| recording | | | | | | |
| Land prepit before | 0.230 | 0.250 | 0.294 | 0.253 | 0.283 | 0.246 |
| recording | | | | | | |

| | | | |
|---|---|---|---|
| Inner/outer push-pull | 4.2 | 12.3 | 17.4 |
| variation before | | | |
| recording | | | |

The optical information-recording medium, on which both of the boundary pit and the boundary groove are formed, has been explained in this embodiment. However, the method for producing the optical information-recording medium of this embodiment can be also applied to an optical information-recording medium on which only the boundary pit is formed or an optical information-recording medium on which only the boundary groove is formed. Accordingly, it is possible to obtain the optical information-recording medium having uniform characteristics on the inner side and the outer side of the medium in the same manner as in this embodiment.

The optical information-recording medium of the present invention has the boundary pit area which is provided between the in-groove pit area and the groove area. Accordingly, it is possible to suppress the tracking error which would be otherwise caused between the in-groove pit area and the groove area. The method for producing the optical information-recording medium of the present invention is useful to produce the optical information-recording medium of the present invention.

When the wide width groove (boundary groove) is provided between the groove formation area and the boundary pit formation area, it is possible to obtain the satisfactory tracking characteristics while maintaining the satisfactory state of the degree of modulation for the boundary pit. Even when only the boundary groove is provided in place of the boundary pit formation area, it is possible to perform the stable servo control.

In the case of the optical information-recording medium in which the in-groove pits are formed and the recording layer composed of the organic dye material is formed according to the present invention, the groove and the land prepit are formed so that they are continuously deepened and widened in the direction from the inner side (inner circumference) to the outer side (outer circumference) of the medium. Accordingly, the height of the interface between the recording layer and the reflective layer formed at the groove portion and the land prepit portion is constant without causing any difference between the inner and outer portions respectively. Therefore, the stable push-pull signal is obtained over the region ranging from the inner circumference to the outer circumference of the medium. Further, it is possible to stably reproduce the data recorded on the land prepits.

What is claimed is:

1. An optical information-recording medium comprising a substrate which is formed with a plurality of lands and grooves, and a recording layer and a reflective layer which are provided on the substrate, the grooves including:
a first groove;
a second groove which is formed with pits; and
a third groove which is formed with pits having widths narrower than those of the pits of the second groove, wherein:
the third groove is arranged between the first groove and the second groove.

2. The optical information-recording medium according to claim 1, wherein Wg≦Wpb≦Wp is satisfied provided that Wg represents a half value width of the first groove, Wp represents a half value width of the pit of the second groove, and Wpb represents a half value width of the pit of the third groove.

3. The optical information-recording medium according to claim 1, wherein Tg≦Tpb≦Tp is satisfied provided that Tg represents a recording layer recess depth ranging from an interface between the recording layer and the reflective layer over a surface of the land to an interface between the recording layer and the reflective layer over the first groove, Tp represents a recording layer recess depth ranging from the interface between the recording layer and the reflective layer over the surface of the land to an interface between the recording layer and the reflective layer over the pit of the second groove, and Tpb represents a recording layer recess depth ranging from the interface between the recording layer and the reflective layer over the surface of the land to an interface between the recording layer and the reflective layer over the pit of the third groove.

4. The optical information-recording medium according to claim 1, wherein the pits, which are formed in the identical groove of the grooves, include a first pit and a second pit which has a length in a groove direction longer than that of the first pit, and 1≦W₂/W₁<1.2 is satisfied provided that W₁ represents a maximum width in a radial direction of the substrate of the first pit, and W₂ represents a maximum width in the radial direction of the substrate of the second pit.

5. The optical information-recording medium according to claim 1, wherein the recording layer is formed of a dye.

6. The optical information-recording medium according to claim 5, wherein each of the first groove, the second groove, and the third groove is formed so that a groove depth is successively deepened and a groove width is successively widened in a direction from an inner side to an outer side of the optical information-recording medium.

7. The optical information-recording medium according to claim 2, wherein a ratio Wp/Wpb between the half value width Wp and the half value width Wpb satisfies 1.05≦Wp/Wpb≦1.15.

8. An optical information-recording medium comprising a substrate which is formed with a plurality of lands and grooves, and a recording layer and a reflective layer which are provided on the substrate, the grooves including:
a first groove;
a second groove which has a width wider than that of the first groove; and
a third groove which is formed with pits, wherein:
the second groove is arranged between the first groove and the third groove.

9. The optical information-recording medium according to claim 8, wherein Wg≦Wgb≦Wp is satisfied provided that Wg represents a half value width of the first groove, Wgb represents a half value width of the second groove, and Wp represents a half value width of the pit of the third groove.

10. The optical information-recording medium according to claim 9, wherein a ratio Wgb/Wg between the half value width Wgb and the half value width Wg satisfies 1.05≦Wgb/Wg≦1.15.

11. The optical information-recording medium according to claim 8, wherein Tg≦Tgb≦Tp is satisfied provided that Tg represents a recording layer recess depth ranging from an interface between the recording layer and the reflective layer over a surface of the land to an interface between the recording layer and the reflective layer over the first groove, Tgb represents a recording layer recess depth ranging from the interface between the recording layer and the reflective layer over the surface of the land to an interface between the recording layer and the reflective layer over the second groove, and Tp represents a recording layer recess depth ranging from the interface between the recording layer and the reflective layer over the surface of the land to an interface between the recording layer and the reflective layer over the pit of the third groove.

12. The optical information-recording medium according to claim 8, wherein the pits, which are formed in the identical groove of the grooves, include a first pit and a second pit which has a length in a groove direction longer than that of the first pit, and 1≦W₂/W₁<1.2 is satisfied provided that W₁ represents a maximum width in a radial direction of the substrate of the first pit, and W₂ represents a maximum width in the radial direction of the substrate of the second pit.

13. The optical information-recording medium according to claim 8, wherein the recording layer is formed of a dye.

14. The optical information-recording medium according to claim 13, wherein the dye is an azo dye.

15. The optical information-recording medium according to claim 13, wherein each of the first groove and the third groove is formed so that a groove depth is continuously deepened and a groove width is continuously widened in a direction from an inner side to an outer side of the optical information-recording medium.

16. The optical information-recording medium according to claim 15, wherein Wgi<Wgo≦Wgb≦Wp is satisfied provided that Wgi represents a half value width of the first groove positioned on the inner side of the optical information-recording medium, Wgo represents a half value width of the first groove positioned on the outer side of the optical information-recording medium, Wgb represents a half value width of the second groove, and Wp represents a half value width of the pit of the third groove.

17. The optical information-recording medium according to claim 16, wherein a ratio Wgo/Wgi between the half value width Wgi and the half value width Wgo satisfies 1.03≦Wgo/Wgi≦1.10.

18. The optical information-recording medium according to claim 15, wherein a ratio dgo/dgi between a depth dgi and a depth dgo satisfies 1.00<dgo/dgi≦1.10 provided that dgi represents the depth of the first groove positioned on the inner side of the optical information-recording medium from a substrate surface, and dgo represents the depth of the first groove positioned on the outer side of the optical information-recording medium from the substrate surface.

19. The optical information-recording medium according to claim 15, wherein Tgi=Tgo<Tgb<Tp is satisfied provided that Tgi represents a recording layer recess depth ranging from an interface between the recording layer and the reflective layer over a surface of the land to an interface between the recording layer and the reflective layer over the first groove positioned on the inner side of the optical information-recording medium, Tgo represents a recording layer recess depth ranging from the interface between the recording layer and the reflective layer over the surface of the land to an interface between the recording layer and the reflective layer over the first groove positioned on the outer side of the optical information-recording medium, Tgb represents a recording layer recess depth ranging from the interface between the recording layer and the reflective layer over the surface of the land to an interface between the recording layer and the reflective layer over the second groove, and Tp represents a recording layer recess depth ranging from the interface between the recording layer and the reflective layer over the surface of the land to an interface between the recording layer and the reflective layer over the pit of the third groove.

20. A method for producing the optical information-recording medium as defined in claim 8, comprising:
exposing a photosensitive material with a pattern corresponding to a first groove, a second groove, and pits of a third groove by irradiating the photosensitive material formed on a master disk with three different exposure intensities;
developing the master disk after the exposure to form the pattern corresponding to the first groove, the second groove, and the third groove equipped with the pits;
forming a substrate with the master disk on which the pattern is formed; and
forming a recording layer and a reflective layer on the substrate.

21. The method for producing the optical information-recording medium according to claim 20, further comprising performing etching by RIE in the development.

22. The method for producing the optical information-recording medium according to claim 21, wherein the exposure is performed with the pattern corresponding to the first groove and the third groove by effecting radiation with an exposure intensity which is continuously changed in a direction from an inner side to an outer side of the master disk.

23. The method for producing the optical information-recording medium according to claim 22, wherein the etching based on RIE is performed while changing a flow rate of a gas to be used for RIE between the inner side and the outer side of the master disk.

24. The method for producing the optical information-recording medium according to claim 20, wherein the exposure intensity is changed during the exposure with the pattern corresponding to the pits such that a first exposure intensity is firstly used, a second exposure intensity, which is lower than the first exposure intensity, is used thereafter, and then the exposure intensity is changed to the first exposure intensity.

25. The method for producing the optical information-recording medium according to claim 24, wherein periods, in which the exposure is performed with the first exposure intensity, are set to 1 T to 1.5 T respectively provided that T represents a clock cycle used when the optical information-recording medium is subjected to reproduction.

26. The method for producing the optical information-recording medium according to claim 20, further comprising performing the exposure with an exposure intensity of zero in addition to the exposure intensities during the exposure of the master disk.

27. An optical information-recording medium comprising a substrate which is formed with a plurality of lands and grooves, and a recording layer and a reflective layer which are provided on the substrate, the grooves including:
a first groove;
a second groove which has a width wider than that of the first groove;
a third groove which is formed with pits; and
a fourth groove which is formed with pits having widths narrower than those of the pits of the third groove, wherein:
the first to fourth grooves are arranged in an order; of the first groove, the second groove, the fourth groove, and the third groove.

28. The optical information-recording medium according to claim 27, wherein Wg≦Wgb≦Wpb≦Wp is satisfied provided that Wg represents a half value width of the first groove, Wgb represents a half value width of the second groove, Wp represents a half value width of the third groove, and Wpb represents a half value width of the fourth groove.

29. The optical information-recording medium according to claim 28, wherein a ratio Wgb/Wg between the half value width Wgb and the half value width Wg satisfies 1.03≦Wgb/Wg≦1.15.

30. The optical information-recording medium according to claim 27, wherein the recording layer is formed of a dye.

31. The optical information-recording medium according to claim 30, wherein each of the first groove, the third groove, and the fourth groove is formed so that a groove depth is successively deepened and a groove width is successively widened in a direction from an inner side to an outer side of the optical information-recording medium.
